(19) United States
(12) Patent Application Publication
(10) Pub. No.: US 2012/0063985 A1
(43) Pub. Date: Mar. 15, 2012

(54) SILICON MANUFACTURING APPARATUS AND SILICON MANUFACTURING METHOD

(75) Inventors: Katsumasa Nakahara, Tokyo (JP); Daisuke Sakaki, Chiba (JP)

(73) Assignee: ASAHI GLASS COMPANY, LIMITED, Tokyo (JP)

(21) Appl. No.: 13/321,574

(22) PCT Filed: May 19, 2010
(86) PCT No.: PCT/JP2010/058446

§ 371 Date: Nov. 21, 2011

(30) Foreign Application Priority Data
May 22, 2009 (JP) 2009-124199

(51) Int. Cl. C01B 33/033; B01J 12/02

(52) U.S. Cl. 423/350; 422/198

(57) ABSTRACT

In a silicon manufacturing apparatus and its related manufacturing method, a zinc gas supply opening (18b, 180b, 181b, 182b, 183b, 184b, 185b, 280a) is placed above a silicon tetrachloride gas opening (16a, 160a). A part of a reactor (10, 100), heated by a heater (22), is set to a silicon depositing temperature range, during which silicon tetrachloride gas is supplied from the silicon tetrachloride gas opening to the reactor to which zinc gas is supplied from the zinc gas supply opening, whereby silicon tetrachloride is reduced with zinc in the reactor to form a silicon depositing region (S), in which silicon is deposited on a wall portion in the reactor corresponding to a region thereof that is set to the silicon depositing temperature range.

### TECHNICAL FIELD

The present invention relates to a silicon manufacturing apparatus and a silicon manufacturing method and, more particularly, to a silicon manufacturing apparatus and its related silicon manufacturing method of forming a silicon depositing region in a reactor or a inner tube thereof.

### BACKGROUND ART

In general, a method of manufacturing high purity silicon includes a Siemens method that has been known to manufacture silicon by chemical vapor deposition using a raw material that is silane compounds such as trichlorosilane resulting from a reaction between crude silicon and hydrogen chloride. The Siemens method is able to manufacture silicon with extremely high purity. However, in the Siemens method, not only a formation reaction is extremely slow in speed but also a yield is low. This results in a need to prepare a large scale equipment in order to have a certain amount of production capacity of silicon. In addition, an electric power consumption for production needs a large electric power as high as 350 kWh per 1 kg of high purity silicon. That is, high purity silicon, produced by the Siemens method, is preferably used for highly integrated electronic devices with increasing added values needed to have purity beyond 11 nines. However, such silicon has excessive quality with high cost for solar cell grade silicon that is regarded to have a rapid market expansion in the future.

Meanwhile, a zinc reduction method, in which silicon tetrachloride is reduced by zinc metal at a high temperature, has been recognized to have verified theory in the 1950's but regarded to be difficult to obtain high purity silicon in comparison with the Siemens method. However, in recent years, silicon for solar cells suffices to be silicon with purity in the order of 6 nines under circumstances where no need arises to have purity as high as that of the highly integrated electronic device. Further, in order to satisfy a rapid market expansion, the zinc reduction method is reviewed and comes under study again as a manufacturing method to obtain silicon with the use of equipment that is compact in structure with a low energy consumption and a low cost. Of course, remnant material or off spec material of silicon, produced in the Siemens method, may be possibly diverted. However, there are certain limitations in ensuring a production volume of silicon with a low cost and, thus, an urgent need arises to develop a zinc reduction method that is able to ensure the production volume with a low cost.

Under such circumstances, there has been a proposal in which the zinc reduction method is employed using a zinc gas introduction opening through which zinc gas is supplied in a lateral direction during which silicon tetrachloride gas is supplied in the lateral direction through a silicon tetrachloride gas introduction opening placed below the zinc gas introduction opening so as to form silicon as gases progressively travel from the zinc gas introduction opening and the silicon tetrachloride gas introduction opening in the lateral direction (see Patent Literature 1).

Another structure has been proposed as the zinc reduction method in which heated silicon tetrachloride gas and zinc gas are brought into contact with each other to allow a solid silicon to deposit on an ejection port of a silicon tetrachloride gas supply pipe (see Patent Literature 2).

### CITATION LIST

### Patent Literature

Patent Literature 1: Japanese Patent Application Laid-Open Publication No. 2004-196642
Patent Literature 2: Japanese Patent Application Laid-Open Publication No. 2007-145663

### SUMMARY OF THE INVENTION

### Problem to be Solved by the Invention

However, upon studies conducted by the present inventors, with the structure proposed in Patent Literature 1, silicon seems to be produced as zinc gas travels from the zinc gas introduction opening and the silicon tetrachloride gas introduction opening both in the lateral direction. But, none of detailed structures is disclosed and it is unclear to find how such a technology is put to practical use.

With the structure proposed in Patent Literature 2, the solid silicon is caused to deposit on only a limited region of the ejection port of the silicon tetrachloride gas supply pipe and such a production region of silicon is narrowed with a limitation in yield, resulting in a difficulty of achieving the realization to ensure a production volume of silicon at low cost.

The present invention has been completed with the above view in mind and has an object to a silicon manufacturing apparatus and a silicon manufacturing method that are able to produce polycrystalline silicon with increased yield at low cost while making it possible to continuously and efficiently collect polycrystalline silicon and that can realize such a structure.

### Means for Solving the Problem

With a view to achieving such an object, one aspect of the present invention provides a silicon manufacturing apparatus comprising: a reactor standing upright in a vertical direction; a silicon tetrachloride gas supply pipe connected to the reactor and having a silicon tetrachloride gas opening through which a silicon tetrachloride gas is supplied to the reactor; a zinc gas supply pipe connected to the reactor and having a zinc gas supply opening through which a zinc gas is supplied to the reactor; and a heater that heats the reactor, wherein the zinc gas supply opening is placed above the silicon tetrachloride gas opening in the vertical direction, and wherein the heater heats a part of the reactor at a temperature lying in a silicon depositing temperature range during which silicon tetrachloride gas is supplied from the silicon tetrachloride gas opening to the reactor to which zinc gas is supplied from the zinc gas supply opening, whereby silicon tetrachloride is reduced with zinc in the reactor to form a silicon depositing region, in which silicon is deposited on a wall portion in the reactor corresponding to a region thereof that is set to the silicon depositing temperature range.

In addition to such a first aspect, the present invention has a second aspect in which the silicon depositing region is an inner wall surface of the reactor corresponding to the region thereof that is set to the silicon depositing temperature range.

In addition to such a first aspect, the present invention has a third aspect in which there is further provided an inner tube detachably mounted inside the reactor, and the silicon depositing region is an inner wall surface of the inner tube mounted inside the reactor corresponding to the region thereof that is set to the silicon depositing temperature range.

In addition to such a third aspect, the present invention has a fourth aspect in which the silicon tetrachloride gas opening and the zinc gas supply opening are placed below an upper end of the inner tube in the vertical direction.

In addition to either one of the first to fourth aspects, the present invention has a fifth aspect in which there is further provided a shock-blow gas supply pipe having a shock-blow gas supply opening connected to the reactor that supplies a shock-blow gas thereto under which the shock-blow gas is supplied from the shock-blow gas supply opening to the reactor to peel off silicon deposited in the silicon depositing region.

In addition to such a fifth aspect, the present invention has a sixth aspect in which the shock-blow gas supply opening is placed below the silicon tetrachloride gas opening in the vertical direction.

In addition to such a fifth or sixth aspect, the present invention has a seventh aspect in which there is further provided a silicon collection vessel connected to the reactor in a lower portion thereof in the vertical direction, and silicon, peeled off from the silicon depositing region, is collected in the silicon collection vessel.

In addition to such a seventh aspect, the present invention has an eighth aspect in which there is further provided a valve disposed between the reactor and the silicon collection vessel and operable to shut off an inside of the reactor from outside, and silicon, peeled off from the silicon depositing region, accumulates on the valve after which opening the valve allows silicon to be collected in the silicon collection vessel.

In addition to either one of the first to eighth aspects, the present invention has a ninth aspect in which the heater includes a heating section that heats the reactor in a upper region thereof on or above the silicon tetrachloride gas opening in the vertical direction at a temperature exceeding the silicon depositing temperature range, and a heating section that heats the reactor in a lower region thereof below the silicon tetrachloride gas opening in the vertical direction at the silicon depositing temperature range.

In addition to either one of the first to ninth aspects, the present invention has a tenth aspect in which further comprising an inert gas supply pipe having an inert gas supply opening communicating with the reactor in a coaxial relationship with the silicon tetrachloride gas supply pipe to supply an inert gas from the inert gas supply opening to the reactor, wherein the inert gas supply opening is placed above the silicon tetrachloride gas supply opening in the vertical direction.

In addition to either one of the first to tenth aspects, the present invention has an eleventh aspect in which the zinc gas supply pipe is connected to the reactor through at least one of a longitudinal wall and an upper lid of the reactor.

In addition to either one of the first to tenth aspects, the present invention has a twelfth aspect in which the reactor has a cylindrical shape and the zinc gas supply pipe communicates with the inside of the reactor through an upper lid thereof and extends in the vertical direction in a coaxial relationship with a center axis of the reactor.

Further, another aspect of the present invention provides a method of manufacturing silicon using a silicon manufacturing apparatus provided with: a reactor standing upright in a vertical direction; a silicon tetrachloride gas supply pipe connected to the reactor and having a silicon tetrachloride gas opening through which a silicon tetrachloride gas is supplied to the reactor; a zinc gas supply pipe connected to the reactor and having a zinc gas supply opening through which a zinc gas is supplied to the reactor, with the zinc gas supply opening being placed above the silicon tetrachloride gas opening in the vertical direction; and a heater that heats the reactor, with the method comprising: setting a part of the reactor at a temperature lying in a silicon depositing temperature range; supplying silicon tetrachloride gas from the silicon tetrachloride gas opening to the reactor; supplying zinc gas from the zinc gas supply opening to the reactor; reducing silicon tetrachloride with zinc in the reactor; and forming a silicon depositing region, in which silicon is deposited on a wall portion in the reactor corresponding to a region thereof that is set to the silicon depositing temperature range.

### Advantageous Effects of the Invention

With the silicon manufacturing apparatus of the first aspect of the present invention, the zinc gas supply opening is placed above the silicon tetrachloride gas opening in the vertical direction, and the heater heats a part of the reactor at a temperature lying in a silicon depositing temperature range during which silicon tetrachloride gas is supplied from the silicon tetrachloride gas opening to the reactor to which zinc gas is supplied from the zinc gas supply opening, whereby silicon tetrachloride is reduced with zinc in the reactor to form a silicon depositing region, in which silicon is deposited on a wall portion in the reactor corresponding to a region thereof that is set to the silicon depositing temperature range. This results in the realization of a structure having expandability that can produce silicon with increased yield at low cost while making it possible to continuously and efficiently collect polycrystalline silicon. Further, such an advantageous effect can be similarly obtained by the silicon manufacturing method of another aspect of the present invention set forth above.

With the structure of the second aspect of the present invention, since the silicon depositing region is present on the inner wall surface of the reactor, silicon can be produced with increased yield in a reliable manner.

With the structure of the third aspect of the present invention, the silicon depositing region, defined on the inner wall surface of the inner tube detachably mounted inside the reactor, provides an increase in yield of silicon. In addition, the inner tube, with the inner wall surface subjected to deterioration, can be easily replaced with another one. This results in a capability of manufacturing silicon without a need to replace the reactor per se.

With the structure of the fourth aspect of the present invention, the silicon tetrachloride gas supply opening and the zinc gas supply opening are located below the upper end of the inner tube in the vertical direction. This causes silicon tetrachloride gas and zinc gas to be surely dispersed in a mixed state, effectively suppressing these gases from undesirably intruding a space between the inner longitudinal wall of the reactor and the outer longitudinal wall of the inner tuber. This results in a consequence of efficiently achieving the reduction reaction to reduce silicon tetrachloride with zinc for enabling the production of silicon with increased yield.

With the structure of the fifth aspect of the present invention, the shock-blow gas is supplied into the reactor from the shock-blow gas supply opening. This results in a capability of peeling off silicon deposited in the silicon depositing region in the absence of direct contact with the inner wall surface of the reactor or the inner tube.

With the structure of the sixth aspect of the present invention, the shock-blow gas supply opening is located below the silicon tetrachloride gas supply opening in the vertical direction. This makes it possible to allow shock-blow gas to surely impinge upon the silicon depositing region in a reliable manner, thereby reliably peeling silicon deposited in the silicon depositing region.

With the structure of the seventh aspect of the present invention, silicon, peeled off from the silicon depositing region, drops downward into the silicon collection vessel, thereby enabling silicon to be reliably collected in the silicon collection vessel.

With the structure of the eighth aspect of the present invention, silicon, peeled off from the silicon depositing region, drops downward by its own weight to accumulate on the valve. Thus, opening the valve results in a effect of causing silicon to drop downward into the silicon collection vessel for collection. When this takes place, during the reduction reaction, the presence of the valve shuts off the inside of the reactor from outside such that the reduction reaction can be continuously and stably established while maintaining reaction environment at a high temperature. Subsequently, if a predetermined amount of silicon is accumulated on the valve when subjected to the shock-blow, then, the valve is opened to cause silicon to drop downward by its own weight into the silicon collection vessel at a normal temperature, after which the valve is closed for collecting silicon from the silicon collection vessel. Thus, silicon can be collected to allow a subsequent reaction to be executed without causing any contamination to the reactor, thereby making it possible to easily and reliably perform a stable continuous operation.

With the structure of the ninth aspect of the present invention, the heater heats the reactor in the upper region on or above the silicon tetrachloride gas supply opening in the vertical direction to the temperature exceeding the silicon depositing temperature range. Meanwhile, the heater heats the reactor in the lower region below the silicon tetrachloride gas supply opening in the vertical direction to the temperature within the silicon depositing temperature range. This enables the inner wall surface of the reactor or the inner wall surface of the inner tube to selectively and reliably define the silicon depositing region.

With the structure of the tenth aspect of the present invention, the inert gas supply opening is provided above the silicon tetrachloride gas supply opening in the vertical direction in communication with the reactor in a coaxial relationship with the silicon tetrachloride gas supply pipe. This enables inert gas to be reliably supplied to the reactor depending on needs with the use of a compact structure.

With the structure of the eleventh aspect of the present invention, the zinc gas supply pipe communicates with the reactor through at least one of the longitudinal wall and the upper lid of the reactor, thereby enabling the realization of a desired dispersion state of zinc gas with a balance in layout with other component parts.

With the structure of the twelfth aspect of the present invention, the reactor has the cylindrical shape and the zinc gas supply pipe is connected to the inside of the reactor through the upper lid thereof so as to extend in the vertical direction in a coaxial relationship with the center axis of the reactor. This enables the apparatus to be formed in a further compact structure that makes it possible to collectively and reliably introduce zinc gas, needed to be maintained at a high temperature, due to its relatively high boiling temperature, and normally needed to have a large volume of gas, into the central region of the reactor in a radial direction thereof, while enabling silicon tetrachloride gas to be dispersively introduced into the reactor around such a central region, in a reliable fashion. Such a compact structure is also able to cause the reduction reaction to occur in a further increased effect for reducing silicon tetrachloride gas with zinc gas for manufacturing polycrystalline silicon with an increase in yield.

### BRIEF DESCRIPTION OF DRAWINGS

FIG. 1 is a schematic longitudinal cross-sectional view of a silicon manufacturing apparatus of a first embodiment according to the present invention.

FIG. 2 is a schematic transverse cross-sectional view of the silicon manufacturing apparatus of the present embodiment and corresponds to a cross section taken on a place A-A of FIG. 1.

FIG. 3A is a schematic longitudinal cross-sectional view of a modified form of the silicon manufacturing apparatus of the present embodiment.

FIG. 3B is a schematic longitudinal cross-sectional view of another modified form of the silicon manufacturing apparatus of the present embodiment.

FIG. 3C is a schematic longitudinal cross-sectional view of still another modified form of the silicon manufacturing apparatus of the present embodiment.

FIG. 4A is a schematic longitudinal cross-sectional view of a further modified form of the silicon manufacturing apparatus of the present embodiment.

FIG. 4B is a schematic longitudinal cross-sectional view of a further modified form of the silicon manufacturing apparatus of the present embodiment.

FIG. 4C is a schematic longitudinal cross-sectional view of a further modified form of the silicon manufacturing apparatus of the present embodiment.

FIG. 5 is a schematic longitudinal cross-sectional view of a silicon manufacturing apparatus of a second embodiment according to the present invention.

FIG. 6 is a schematic transverse cross-sectional view of the silicon manufacturing apparatus of the present embodiment and corresponds to a cross section taken on a place B-B of FIG. 5.

FIG. 7 is a schematic longitudinal cross-sectional view of a silicon manufacturing apparatus of a third embodiment according to the present invention.

FIG. 8 is a schematic transverse cross-sectional view of the silicon manufacturing apparatus of the present embodiment and corresponds to a cross section taken on a place C-C of FIG. 7.

FIG. 9 is a schematic longitudinal cross-sectional view of a silicon manufacturing apparatus of a fourth embodiment according to the present invention.

FIG. 10 is a schematic transverse cross-sectional view of the silicon manufacturing apparatus of the present embodiment and corresponds to a cross section taken on a place D-D of FIG. 9.

FIG. 11A is a schematic, transverse enlarged cross-sectional view of a zinc gas supply pipe incorporated in the silicon manufacturing apparatus of the present embodiment and corresponds to a cross section taken on a plane E-E of FIG. 9.

FIG. 11B is a schematic, transverse enlarged cross-sectional view of a silicon tetrachloride gas supply pipe incorporated in the silicon manufacturing apparatus of the present embodiment and corresponds to a cross section taken on a plane F-F of FIG. 9.

### EMBODIMENTS FOR CARRYING OUT THE INVENTION

Hereinafter, silicon manufacturing apparatuses and their related methods of various embodiments according to the present invention will be described in detail with reference to the accompanying drawings. Throughout the drawings, x-, y- and z-axes represent a three-axis orthogonal coordinate system with the z-axis assigned to indicate a vertical direction in a longitudinal direction in which the z-axis has a negative direction assigned to be a lower side indicative of a downstream side.

### First Embodiment

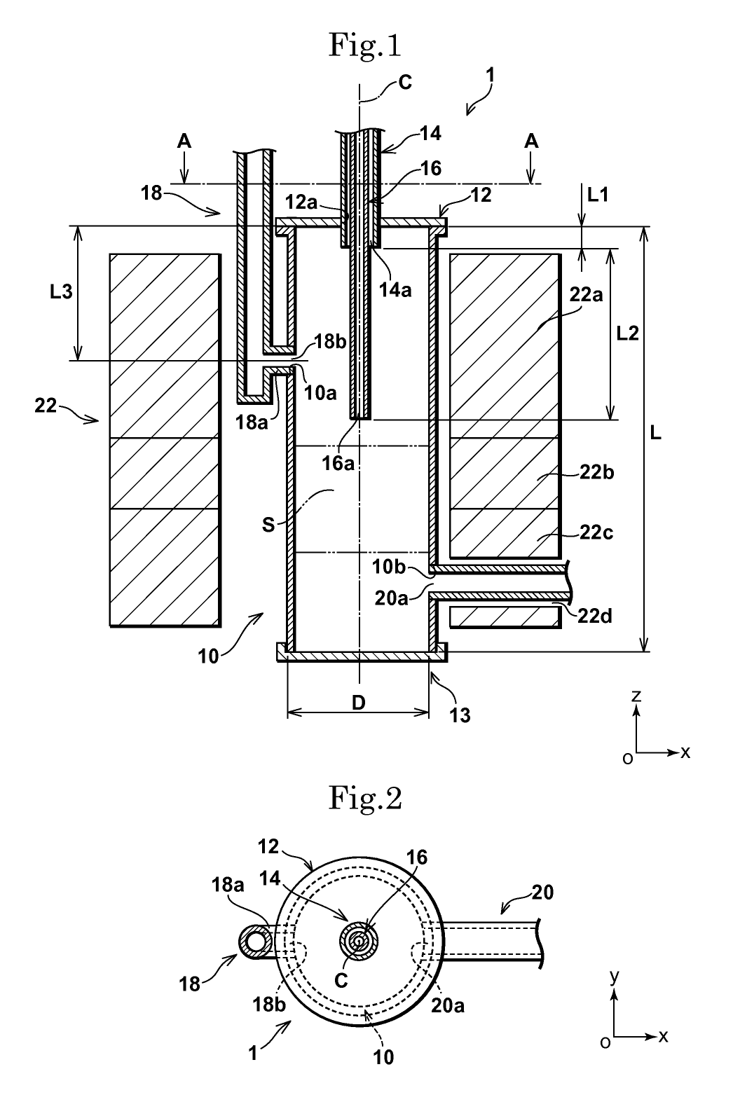

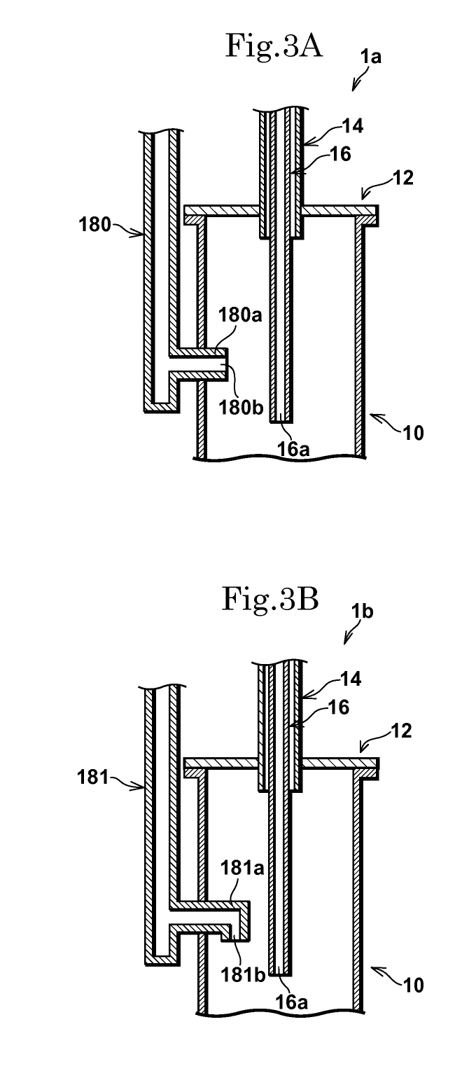

First, a silicon manufacturing apparatus and its related method of a first embodiment according to the present invention will be described below in more detail with reference to FIGS. 1 and 2.

FIG. 1 is a schematic and longitudinal cross-sectional view of the silicon manufacturing apparatus of the first embodiment. FIG. 2 is a schematic transverse cross-sectional view of the silicon manufacturing apparatus of the present embodiment and corresponds to a cross-sectional view taken on a plane A-A of FIG. 1.

As shown in FIGS. 1 and 2, the silicon manufacturing apparatus 1 is provided with a reactor 10, having a typically cylindrical shape and extending in the vertical direction and in a coaxial relationship with a centerline C extending in parallel to the z-axis, for achieving a reduction reaction to reduce silicon tetrachloride with zinc. The reactor 10, made of quartz glass, has a longitudinal wall, formed with an insertion hole 10a, and an insertion hole 10b formed at a position below the insertion hole 10a. In addition, the reactor 10 has an upper open end to which a circular disc-shaped upper lid 12, made of quartz glass, is fixedly attached to close the upper open end. The reactor 10 has a lower open end to which a circular disc-shaped bottom plate 13, made of quartz glass, is detachably mounted to close the lower open end.

Here, with the silicon manufacturing apparatus 1, the reactor 10 takes the form of a reactor of a longitudinal type having an elongated dimension between a mating surface of the upper lid 12 with respect to the reactor 10 and another mating surface of the bottom plate 13 with respect to the reactor 10 in length L greater than a diameter D of the reactor 10. The reactor 10 has an inside to which zinc gas is introduced in a position above (on an upstream side of) a position at which silicon tetrachloride gas is introduced. A depositing region in which silicon is deposited is defined in a partial region of the reactor 10 below (on a downstream side of) a position at which silicon tetrachloride gas is introduced, with the reactor 10 being preferably set to a temperature so as to cause the reduction reaction to occur for deposition of silicon to be collected from a lower portion (a further downstream side) of the reactor 10.

More particularly, the upper lid 12, closing the upper open end of the reactor 10, has an insertion hole 12a formed in a coaxial relationship with the center axis C. An inert gas supply pipe 14, made of quartz glass, is inserted to and fixedly attached to the insertion hole 12a in communication with an inert gas supply source, which is not shown. The inert gas supply pipe 14 has a leading end exposed to the inside of the reactor 10 to vertically extend downward in a coaxial relationship with the center axis C. Moreover, the inert gas supply pipe 14 internally accommodates therein a silicon tetrachloride gas supply pipe 16, made of quartz glass, which is held in communication with the silicon tetrachloride gas source, which is not shown. The silicon tetrachloride gas supply pipe 16 penetrates into the reactor 10 so as to vertically extend downward in a coaxial relationship with the center axis C in the reactor 10.

Further, the inert gas supply pipe 14 has an end portion, located inside the reactor 10, which has an inert gas supply opening 14a available for ejecting inert gas at an end portion of the inert gas supply pipe 14. Likewise, the silicon tetrachloride gas supply pipe 16 has an end portion, located inside the reactor 10, which has a silicon tetrachloride gas supply opening 16a operative to eject silicon tetrachloride gas at an end portion of the silicon tetrachloride gas supply pipe 16. In addition, the silicon tetrachloride gas supply pipe 16 may be able to be connectable to the inert gas supply source, which is not shown, depending on needs.

Here, the inert gas supply opening 14a is opened so as to face vertically downward in the inside of the reactor 10 at a position spaced from the mating surface of the upper lid 12 with respect to the reactor 10 by a length of L1. Further, the silicon tetrachloride gas supply opening 16a is opened so as to face vertically downward in the inside of the reactor 10 at a position spaced from the mating surface of the upper lid 12 with respect to the reactor 10 by a length of L2 (with L2>L1). That is, the inert gas supply opening 14a has an opening position placed above an opening position of the silicon tetrachloride gas supply opening 16a.

Meanwhile, a zinc gas supply pipe 18, made of quartz glass, is inserted to the insertion hole 10a, formed on the longitudinal wall of the reactor 10, and connected to the zinc gas supply source, which is not shown. In particular, the zinc gas supply pipe 18 has a portion vertically extending along the reactor 10 and, in addition hereto, has a connecting portion 18a, extending orthogonal to the center axis C, which is inserted to the insertion hole 10a of the reactor 10 and fixedly connected thereto. Moreover, under a circumstance where the reactor 10 can have the diameter D that can be set to be large enough and a diameter of the upper lid 12 can be set to be large enough, the zinc gas supply pipe 18 may be connected to the inside of the reactor 10 through the upper lid 12.

Of course, the zinc gas supply source may be provided as an independent zinc gas supply device with respect to a portion of the zinc gas supply pipe 18 that vertically extends along the reactor 10. In an alternative structure, a zinc wire may be introduced to such a portion of the zinc gas supply pipe 18 that vertically extends along the reactor 10 to be heated by a heater, which is described later in detail, at a temperature above a boiling point of the zinc wire for gasification. In addition, a stream of inert gas may be admitted to the zinc gas supply pipe 18 from the inert gas supply source, which is not shown, depending on needs.

The zinc gas supply pipe 18 may be welded to the reactor 10 at the insertion hole 10a, formed in the reactor 10, to be configured in a unitary structure with the reactor 10 so as to be preferable in view of durability. Further, the zinc gas supply pipe 18 is connected to the inside of the reactor 18. In particular, an end portion of the zinc gas supply pipe 18 as a closer end portion with respect to the reactor 10, i.e., an end portion of the connecting portion 18a, is in a coplanar relationship with an inner wall surface of the longitudinal wall of the reactor 10 and has a zinc gas supply opening 18b that is opened so as to face radially inward in the inside of the reactor 10 available for ejecting zinc gas thereto.

Here, an opening position of the zinc gas supply opening 18b, i.e., a center position of the zinc gas supply opening 18b in the vertical direction, is located at a position spaced from the mating surface of the upper lid 12 with respect to the reactor 10 by a length of L3 (with L3<L2).

That is, the opening position of the zinc gas supply opening 18b is placed to, be higher than the opening position of the silicon tetrachloride gas supply opening 16a. Further, as far as the opening position of the zinc gas supply opening 18b is placed to be higher than the opening position of the silicon tetrachloride gas supply opening 16a, the silicon tetrachloride gas supply pipe 16 and the zinc gas supply pipe 18 may be connected to the reactor 10 at the longitudinal wall, the upper lid 12 of the reactor 10 or the like, in principle, on appropriate choice of design.

Furthermore, an exhaust pipe 20, made of quartz glass, is inserted to the insertion hole 10b that is formed on the longitudinal wall of the reactor 10, in communication with an exhaust gas treatment device, which is not shown. The exhaust pipe 20 may be welded to the reactor 10 at the insertion hole 10b, formed in the reactor 10, to be configured in a unitary structure with the reactor 10 so as to be preferable in view of durability. Moreover, the exhaust pipe 20 has a closer end portion with respect to the reactor 10 that is in a coplanar relationship with an inner wall surface of the longitudinal wall of the reactor 10 and has an exhaust gas introduction opening 20a that is opened so as to face radially inward in the inside of the reactor 10.

Further, the longitudinal wall of the reactor 10 is surrounded with a heater 22 placed outside the reactor 10. The heater 22 is typically a cylindrically shaped electric heater that is placed in a coaxial relationship with the center axis C and provided with a first heating section 22a, a second heating section 22b and a third heating section 22c vertically placed downward in such an order, with the third heating section 22c having a through-bore 22d through which the exhaust pipe 22 penetrates.

More particularly, the first heating section 22a serves as a heating section operable to heat the reactor 10 to be sustained at a temperature (for instance, 1200° C.) that exceeds a depositing temperature at which silicon is deposited. Specifically, the first heating section 22a surrounds a part of the longitudinal wall and the inside of the reactor 10 in which the inert gas supply pipe 14 having the inert gas supply opening 14a, the silicon tetrachloride gas supply pipe 16 having the silicon tetrachloride gas supply opening 16a and the connecting portion 18a of the zinc gas supply pipe 18 having the zinc gas supply opening 18b are disposed, respectively. In addition, the first heating section 22a surrounds a part of the zinc gas supply pipe 18 that extends in the vertical direction. Thus such a part of the longitudinal wall and the inside of the reactor 10 and such a part of the zinc gas supply pipe 18 are heated and sustained at the temperature above the depositing temperature at which silicon is deposited.

Here, a depositing temperature range, at which silicon is deposited, can be evaluated to preferably include a temperature ranging between 950° C. or more and 1100° C. or less. The reason for setting such a depositing temperature range is stated below in more detail. That is, if the longitudinal wall and the inside of the reactor 10 lay at the temperature less than 950° C., then, the reduction reaction takes place with a slow reaction rate in reducing silicon tetrachloride with zinc. On the contrary, if each temperature of the longitudinal wall and the inside of the reactor 10 exceeds 1100° C., then, silicon becomes stable to be present in the form of gaseous compound of silicon tetrachloride rather than to be present in the form of a solid material, and, therefore the reduction reaction cannot occur. In addition, zinc has a boiling point of 910° C. and, therefore, the depositing temperature range per se, at which silicon is deposited, falls in a temperature range that exceeds the boiling point of zinc.

Further, the second heating section 22b and the third heating section 22c, contiguous with the second heating section 22b in a vertically downward position of the second heating section 22b, serve as heating sections to heat the reactor 10 to be sustained at the respective temperatures falling in the depositing temperature range at which silicon is deposited. The first and second heating sections 22b and 22c continuously and vertically surround a lower region of the longitudinal wall and the inside of the reactor 10 in which none of the inert gas supply pipe 14, the silicon tetrachloride gas supply pipe 16 and the zinc gas supply pipe 18 is located. This allows such a region to be heated and sustained at the depositing temperature at which silicon is deposited.

Here, the second heating section 22b serves as a heating section operable to heat the longitudinal wall and the inside of the reactor 10 at a lower region of the reactor 10, at the temperature (for instance, 1100° C.) falling in the depositing temperature range at which silicon is deposited. The third heating section 22c serves as a heating section operable to heat the longitudinal wall and the inside of the reactor 10 in a region thereof below the portion that is heated with the second heating section 22b. The third heating section 22c heats such a region at the temperature (for instance, 1000° C.), falling in the depositing temperature range at which silicon is deposited, but such a heating temperature of the third heating section 22c is lower than that of the second heating section 22b.

The second heating section 22b serves to provide an intermediate heating temperature between the heating temperatures of the first and third heating sections 22a and 22c but may be omitted with depending on needs. In any event, a heating section is preferably provided so as to suffice the heating of the longitudinal wall and the inside of the reactor 10 at the temperature, falling in the depositing temperature range at which silicon is deposited, in a region including none of the silicon tetrachloride gas supply pipe 16 and the connecting portion 18a of the zinc gas supply pipe 18 is provided, and so as to be located vertically below the first heating section 22a operative to heat the longitudinal wall and the inside of the reactor 10 in the region where the silicon tetrachloride gas supply pipe 16, having the silicon tetrachloride gas supply opening 16a, the connecting portion 18a of the zinc gas supply pipe 18, having the zinc gas supply opening 18b and the like, at the temperature exceeding the depositing temperature at which silicon is deposited. In addition, the second heating section 22b may also have a function to adjust a difference between the heating temperatures of the first and third heating sections 22a and 22c such that the difference does not increase in excess for thereby suppressing an excess in variation of the temperatures of the wall surface and the like in the reactor 10.

In addition, such a structure results in a consequence of causing all of the heating temperatures of the first to third heating sections 22a to 22c of the heater 22 to exceed a value of 910° C. representing the boiling point of zinc.

Next, a silicon manufacturing method for manufacturing polycrystalline silicon with the use of the silicon manufacturing apparatus 1 set forth above will be described below in detail. In the following, a series of steps forming the silicon manufacturing method may be automatically controlled using a controller having a variety of data bases by referring to detected data derived from various sensors. In an alternative, a part of or all of the steps may be manually executed.

Firstly, with the bottom plate 13 mounted on the reactor 10 at the lower end of the reactor 10 to shut off the inside of the reactor 10 from outside, a stream of inert gas is supplied into the reactor 10 from the inert gas supply opening 14a for a predetermined time span for adjusting a reaction environment inside the reactor 10. During such step, it doesn't matter if the stream of inert gas is supplied through the silicon tetrachloride gas supply opening 16a and the zinc gas supply opening 18b for the predetermined time span depending on needs.

Next, the first heating section 22a of the heater 22 is energized to heat the upper region of the longitudinal wall and the inside of the reactor 10. Such an upper region of the longitudinal wall and the inside of the reactor 10 involves the region provided with the inert gas supply pipe 14 having the inert gas supply opening 14a, the silicon tetrachloride gas supply pipe 16 having the silicon tetrachloride gas supply opening 16a and the connecting portion 18a of the zinc gas supply pipe 18 having the zinc gas supply opening 18b and a part of the zinc gas supply pipe 18 in which the zinc gas supply pipe 18 extends in the vertical direction. Thus, the upper region of the longitudinal wall and its associated inside of the reactor 10 and the region, in which the zinc gas supply pipe 18 extends in the vertical direction, are heated and sustained at the temperatures exceeding the depositing temperature at which silicon is deposited. Simultaneously, the second and third heating sections 22b and 22c of the heater 22 are energized to heat the lower region of the longitudinal wall and its associated inside of the reactor 10 in which there is provided none of the inert gas supply pipe 14, the silicon tetrachloride gas supply pipe 16 and the zinc gas supply pipe 18. The second and third heating sections 22b and 22c heat such a lower region of the longitudinal wall and the inside of the reactor 10 to be maintained at the temperatures within the silicon depositing temperature range.

Subsequently, a reduction reaction step is carried out with such temperature conditions being sustained. More particularly, a stream of silicon tetrachloride gas is introduced to the inside of the reactor 10 from the silicon tetrachloride gas supply opening 16a, and a stream of zinc gas is introduced to the inside of the reactor 10 from the zinc gas supply opening 18b. When this takes place, inert gas may be supplied from the inert gas supply opening 14a depending on needs.

This results in a consequence of causing the reduction reaction to take place in the inside of the reactor 10 for reduction of silicon tetrachloride with zinc. Here, silicon tetrachloride gas is relatively heavy gas having a specific gravity approximately 2.6 times greater than that of zinc gas. Thus, silicon tetrachloride gas cannot be substantially dispersed to a region around the zinc gas supply opening 18b located above the opening position of the silicon tetrachloride gas supply opening 16a. This results in an effect of causing the reduction reaction to occur in the reactor 10 at a region adjacent to or lower than the silicon tetrachloride gas supply opening 16a. That is, this results in a consequence of manufacturing a solid silicon and zinc tetrachloride gas in such a region.

Furthermore, the second and third heating sections 22b and 22c heat the lower region of the longitudinal wall of the reactor 10, in which there is provided none of the inert gas supply pipe 14, the silicon tetrachloride gas supply pipe 16 and the zinc gas supply pipe 18 is provided, to be sustained at the silicon depositing temperature range. Thus, silicon, produced in the reduction reaction, is deposited on the longitudinal wall of the reactor 10 at the lower region of the reactor 10. That is, silicon is progressively deposited as acicular crystals in the depositing region S representing a region defined on the inner wall surface of the reactor 10 above the exhaust gas introduction opening 20a and below the silicon tetrachloride gas supply opening 16a. In this moment, no possibility occurs for silicon to be deposited on the silicon tetrachloride gas supply opening 16a and the zinc gas supply opening 18b, and this results in no occurrence of such supply openings to be clogged by silicon.

In such a manner, further, the acicular crystals of silicon are sequentially deposited in the depositing region S formed on the internal wall surface of the reactor 10 at the lower region thereof, with resultant crystal growth of silicon progressively occurring, while the crystal growth starts from a seed crystal of silicon that is resulted from the deposition in the depositing region S. This result the formation of polycrystalline silicon accumulated with an adequate thickness. Here, such a process of deposition and related step of crystal growth will be collectively referred to as “deposition”.

Then, such a reduction reaction continues for a predetermined time span, after which the supply of silicon tetrachloride gas and zinc gas, both serving as reaction feed materials, is stopped with the interruption of energizing the heater 22. Under such a state with only inert gas being supplied, remnant silicon tetrachloride gas and zinc gas as well as byproduct of zinc chloride gas are caused to exhaust from the exhaust gas pipe 20 and cooled down to a normal temperature.

Subsequently, the bottom plate 13 is dismounted from the reactor 10 to allow a peeling member to enter into the reactor 10 from the downward open end of the reactor 10. Then, polycrystalline silicon, accumulated in the depositing region S defined on the internal wall surface of the reactor 10 at the lower region thereof for collection, is peeled off, upon which the series of steps of manufacturing silicon in the current process is completed. In addition, such polycrystalline silicon may be possibly peeled off and collected by application of vibration.

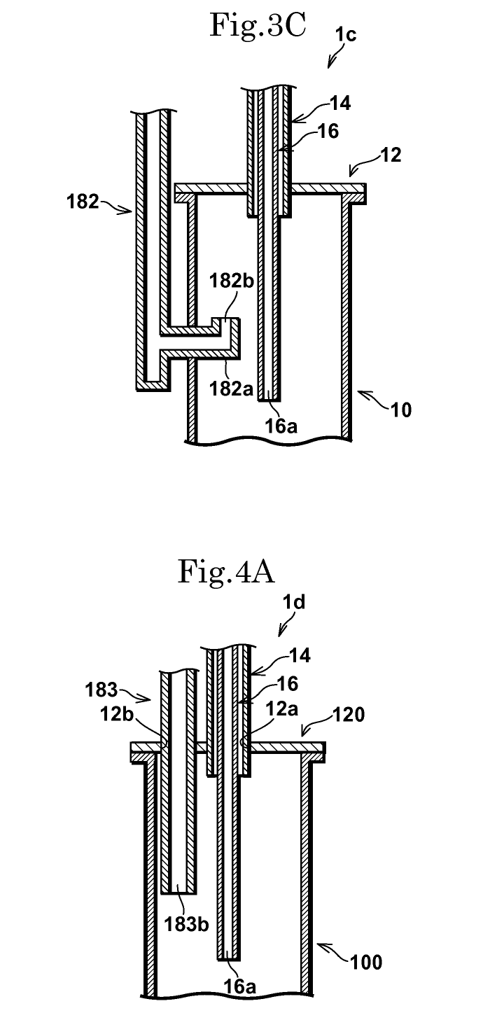

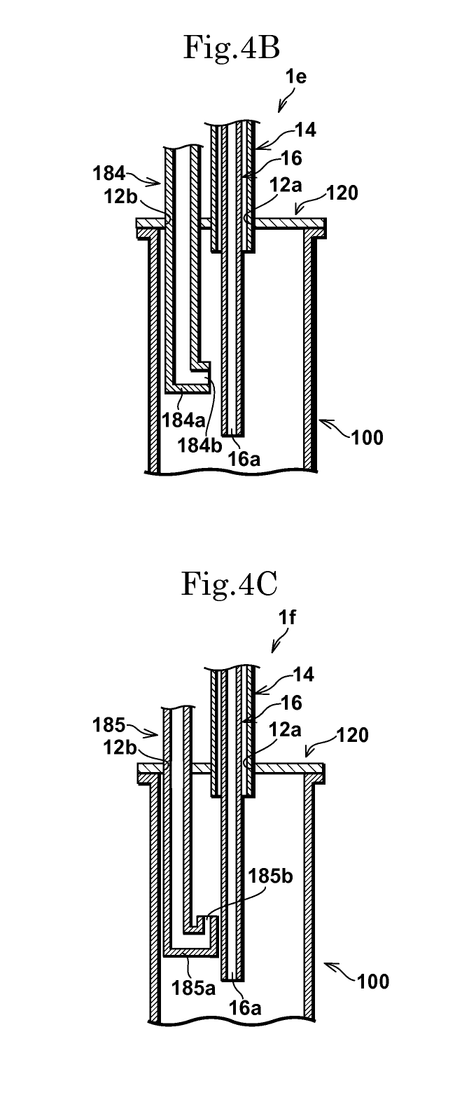

Besides, with the silicon manufacturing apparatus 1 of such a structure set forth above, the zinc gas supply pipe may be conceivably structured in various modifications. That is, the zinc gas supply pipe may be connected to the longitudinal wall of the reactor 10 to penetrate into the inside thereof. In another alternative, the zinc gas supply pipe may be connected to the reactor 10 by means of the upper lid 12 thereof. Modified forms of such a zinc gas supply pipe will be described below in detail with reference further to FIGS. 3 and 4. With each modification, the silicon manufacturing apparatus mainly differs from the silicon manufacturing apparatus 1 of the present embodiment in respect of a structure of the zinc gas supply pipe with the other components remained identical in structure. Therefore, each modification will be described below in detail with a focus on such a differing point with the same component parts bearing like reference numerals to suitably simplify or omit the relevant description.

FIGS. 3A to 4C are schematic longitudinal cross-sectional views showing various modifications of the silicon manufacturing apparatus of the present embodiment and correspond to the structure shown in FIG. 1 in positional relationship.

With a structure of a silicon manufacturing apparatus 1a shown in FIG. 3A, more particularly, a zinc gas supply pipe 180 has a connecting portion 180a that protrudes into the reactor 10 to allow a zinc gas supply opening 180b to be opened so as to face radially inward at a position in which an end portion of the zinc gas supply pipe 180 remains entered into and protruded to the inside of the reactor 10. With a structure of a silicon manufacturing apparatus 1b shown in FIG. 3B, a zinc gas supply pipe 181 has a connecting portion 181a that not only protrudes into the reactor 10 but also is bent vertically downward to allow a zinc gas supply opening 181b to be opened so as to face vertically downward in the inside of the reactor 10. Meanwhile, with a structure of a silicon manufacturing apparatus 1c shown in FIG. 3C, a zinc gas supply pipe 182 has a connecting portion 182a that not only protrudes into the reactor 10 but also is vent vertically upward to allow a zinc gas supply opening 182b to be opened so as to face vertically upward in the inside of the reactor 10.

With the modifications set forth above, an ejecting position and an ejecting direction of zinc gas may be suitably determined. This enables the zinc gas supply pipe to be realized in structure with increased freedom of design while causing zinc gas to be dispersed in a desired state inside the reactor 10.

With a structure of a silicon manufacturing apparatus 1d shown in FIG. 4A, no insertion hole 10a is formed on the longitudinal wall of a reactor 100. Further, an upper lid 120, made of quartz glass and adapted to close an upper open end of the reactor 100, is formed not only with the insertion hole 12a but also with the neighboring insertion hole 12b. That is, no zinc gas supply pipe 183 is inserted to the longitudinal wall of the reactor 100. Such a zinc gas supply pipe 183 is inserted and fixed to the insertion hole 12b adjacent to the insertion hole 12a, to which the inert gas supply pipe 14 is inserted, such that a zinc gas supply opening 183b is opened so as to face vertically downward at a position in which the zinc gas supply pipe 183 remains protruded to the inside of the reactor 100. With a structure of a silicon manufacturing apparatus 1 shown in FIG. 4B, further, a zinc gas supply pipe 184 protrudes into the reactor 100 and is bent radially inward to allow a zinc gas supply opening 184b to be opened so as to face radially inward in the inside of the reactor 100. Meanwhile, with a structure of a silicon manufacturing apparatus 1f shown in FIG. 4C, a zinc gas supply pipe 185 protrudes into the reactor 100 and is bent radially inward with an end portion being further bent vertically upward, in the inside of the reactor 100. This allows a zinc gas supply opening 185b of the zinc gas supply pipe 185 to be opened so as to face vertically upward in the inside of the reactor 100. With the structure shown in FIG. 4A, although the zinc gas supply pipe 183 protrudes into the reactor 100, the zinc gas supply pipe 183 may be designed not to protrude in such a configuration and the zinc gas supply opening 185b may be possible to align in a coplanar relationship with a bottom surface of the upper lid 120.

With the modifications set forth above, the zinc gas supply pipe may be realized in various structure with increased freedom of design on consideration of handling capability in layout of the zinc gas supply pipe, encountered in the presence of a narrow space between the reactor and a heating furnace, and complicated work encountered when the zinc gas supply pipe is unitized with the reactor. It is, of course, to be understood that the structures of such various modifications, mentioned above, can be adopted in any suitable combinations.

In the structure of the present embodiment, involving the various modifications, set forth above, the zinc gas supply opening is placed above the silicon tetrachloride gas opening in the vertical direction, and the heater heats a part of the reactor at a temperature lying in a silicon depositing temperature range during which silicon tetrachloride gas is supplied from the silicon tetrachloride gas opening to the reactor to which zinc gas is supplied from the zinc gas supply opening, whereby silicon tetrachloride is reduced with zinc in the reactor to form a silicon depositing region, in which silicon is deposited on a wall portion in the reactor corresponding to a region thereof that is set to the silicon depositing temperature range. This results in the realization of a structure having expandability that can produce silicon with increased yield at low cost while making it possible to continuously and efficiently collect polycrystalline silicon.

Further, since the silicon depositing region is present on the inner wall surface of the reactor, silicon can be produced with increased yield in a reliable manner.

Furthermore, the heater heats the reactor in the upper region on or above the silicon tetrachloride gas supply opening in the vertical direction to the temperature exceeding the silicon depositing temperature range. Meanwhile, the heater heats the reactor in the lower region below the silicon tetrachloride gas supply opening in the vertical direction to the temperature within the silicon depositing temperature range. This enables the inner wall surface of the reactor or the inner wall surface of the inner tube to selectively and reliably define the silicon depositing region.

Moreover, the inert gas supply opening is provided above the silicon tetrachloride gas supply opening in the vertical direction in communication with the reactor in a coaxial relationship with the silicon tetrachloride gas supply pipe. This enables inert gas to be reliably supplied to the reactor depending on needs with the use of a compact structure.

In addition, the zinc gas supply pipe communicates with the reactor through at least one of the longitudinal wall and the upper lid of the reactor, thereby enabling the realization of a desired dispersion state of zinc gas with a balance in layout with other component parts.

### Second Embodiment

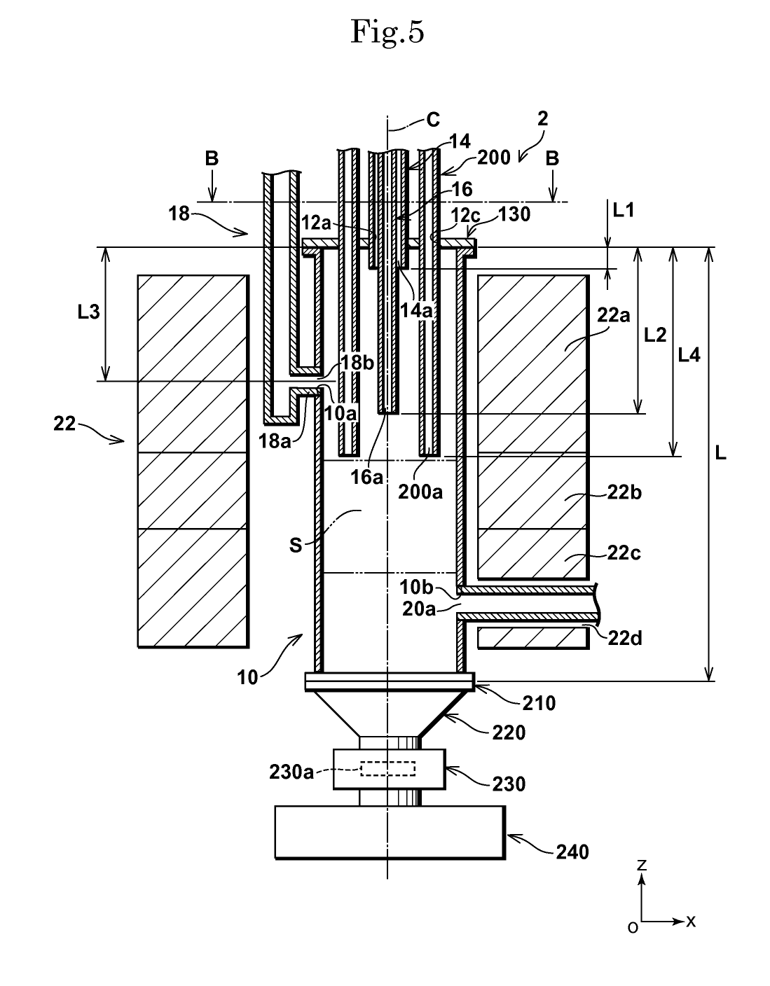

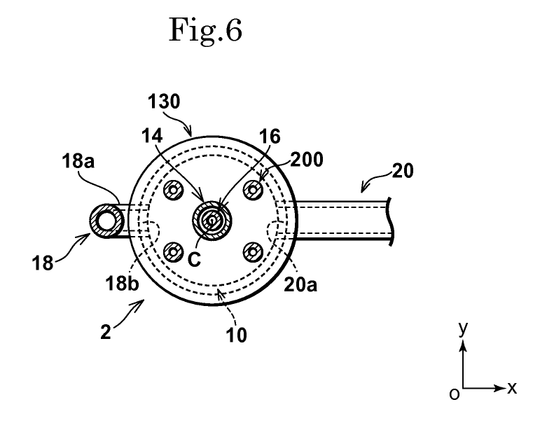

Next, a silicon manufacturing apparatus and its related method of a second embodiment according to the present invention will be described below in more detail with reference to FIGS. 5 and 6.

FIG. 5 is a schematic longitudinal cross-sectional view showing the silicon manufacturing apparatus of the present embodiment. FIG. 6 is a schematic transverse cross-sectional view showing the silicon manufacturing apparatus of the present embodiment and corresponding to a cross section B-B of FIG. 5.

The silicon manufacturing apparatus 2 of the present embodiment mainly differs from the silicon manufacturing apparatus 1 of the first embodiment in that the silicon manufacturing apparatus 2 of the present embodiment additionally includes a shock-blow gas supply pipe and an associated silicon collection vessel, with other component parts remained identical in structure. Therefore, the present embodiment will be described below with a focus on such a differing point with the same component parts bearing like reference numerals to suitably simplify or omit the relevant description.

As shown in FIGS. 5 and 6, in contrast to the structure of the silicon manufacturing apparatus 1 of the first embodiment, the silicon manufacturing apparatus 2 of the present embodiment includes a disc-shaped upper lid 130, made of quartz glass, to close an upper open end of the reactor 10. The upper lid 130 has not only the insertion hole 12a to which the inert gas supply pipe 14 is inserted but also each insertion hole 12c formed in a portion adjacent to the insertion hole 12a. Each shock-blow gas supply pipe 200, made of quartz glass, is inserted and fixedly secured to the insertion hole 12c in communication with a high pressure inert gas supply source, which is not shown. The shock-blow gas supply pipe 200 enters into the inside of the reactor 10 and extends vertically downward along the inner wall surface of the reactor 10. Further, the shock-blow gas supply pipe 200 has an end portion, placed inside the reactor 10, which is formed with a shock-blow gas supply opening 200a.

Here, the shock-blow gas supply pipe 200 serves to allow the shock-blow gas supply opening 200a to inject inert gas under high pressure so as to allow such inert gas to impinge upon polycrystalline crystal accumulated in the depositing region S defined on the inner wall surface of the reactor 10 at the lower region thereof for thereby peeling off such polycrystalline crystal accumulated in the depositing region S.

Therefore, the shock-blow gas supply pipe 200 may preferably include a plurality of pipe components (with four shock-blow gas supply pipes shown in FIG. 6) that are disposed in positions each on axial symmetry with respect to the center axis C so as to extend in the inside of the reactor 10 along the inner wall surface of the reactor 10. Under such a case, the upper lid 130 is formed with a plurality of associated insertion holes 12c (with four insertion holes shown in FIG. 6). In addition, the shock-blow gas supply pipes 200 have shock-blow gas supply openings 200a each of which is opened so as to face vertically downward in the inside of the reactor 10 at a position spaced from a mating surface of the reactor 10 with respect to the upper lid 130 by a length of L4. Since the shock-blow gas supply openings 200a have a need to eject inert gas under high pressure to the depositing region S defined on the inner wall surface of the reactor 10 at the lower region thereof. Thus, the shock-blow gas supply openings 200a is to be preferably located in positions adjacent to or above such depositing region S. Typically, the opening positions of the shock-blow gas supply openings 200a is to be preferably located in positions below the opening position of the silicon tetrachloride gas supply opening 16a (with L4>L2) and above the depositing region S. In addition, although the shock-blow gas supply pipes 200 become complicated in arrangement, the opening positions of the shock-blow gas supply openings 200a may be located in positions below the depositing region S to enable inert gas to be ejected upward under high pressure.

A condition for the shock-blow preferably includes a pressure and a blowing time span under which inert gas is ejected from the shock-blow gas supply openings 200a. If such a pressure is too low, then, silicon deposited on the depositing region S cannot be adequately peeled off. In contrast, if such a pressure is too high, then, there is a tendency of causing damages to the longitudinal wall of the reactor 10 and the shock-blow gas supply pipes 200. Therefore, the shock-blow may be preferably conducted under a pressure falling in a range 0.1 MPa and more and 1.0 MPa and less and, in actual practice, such a pressure may fall in a range of 0.3 MPa or more and 0.6 MPa or less. If the blowing time span is too short, then, silicon deposited on the depositing region S cannot be adequately peeled off. In contrast, if such a blow is too long, then, a rate of inert gas being introduced increases with a tendency of causing a decrease in the temperature of the reactor 10 while exhaust gases are discharged accompanied with peeled-off silicon with a resultant difficulty of collecting silicon. Therefore, the blowing time span may preferably fall in a range of 0.1 seconds or more and 3.0 seconds or less. Moreover, the shock-blow for such blowing time span may be cyclically repeated in plural steps at predetermined time intervals. In addition, the shock-blow gas supply pipes 200 and the shock-blow gas supply openings 200a may have diameters that can be suitably determined depending on a diameter of the reactor 10 and the pressure, etc., under which the shock-blow is accomplished.

Further, with the silicon manufacturing apparatus 2, when a stream of inert gas under high pressure, ejected from the shock-blow gas supply openings 200a, impinges upon the depositing region S of the reactor 10 at the lower region of the inner wall surface thereof, polycrystalline silicon, accumulated in such a depositing region S, is peeled off to drop downward under its own weight. To this end, a connecting member 210, a connecting pipe 220, a valve device 230 and a silicon collection vessel 240 are provided to the reactor 10 at a lower portion of the reactor 10 in such an order.

More particularly, in place of the bottom plate 13 mounted in the silicon manufacturing apparatus 1 of the first embodiment, the connecting member 210 is provided on the silicon manufacturing apparatus 2 for allowing the lower portion of the reactor 10 and the connecting pipe 220 to be connected to each other. In addition, the valve device 230 is provided between the connecting pipe 220 and the silicon collection vessel 240.

Such a valve device 230 includes a valve 230a operative to shut off an environment of the inside of the reactor 10 from outside environment. With the valve 230a being closed for shutting off the communication between the inside of the reactor 10 and the silicon collection vessel 240, polycrystalline silicon deposited on the depositing region S is peeled off therefrom, while the stream of inert gas, ejected from the shock-blow gas supply openings 200a, impinges on polycrystalline silicon deposited on the depositing region S under high pressure, and, then, such polycrystalline silicon that is peeled off drops by its own weight and is able to be accumulated on the valve 230a. In contrast, with the valve 230a being opened, the inside of the reactor 10 and the silicon collection vessel 240 are brought into communication with each other. This allows polycrystalline silicon, accumulated on the valve 230a, to drop by its own weight into the silicon collection vessel 240 for collection.

Further, the silicon collection vessel 240 is placed under atmosphere, which is the outside of the heating region, at a normal temperature and detachably mounted with respect to the silicon manufacturing apparatus 2.

Next, a silicon manufacturing method for manufacturing polycrystalline silicon with the use of the silicon manufacturing apparatus 2 of such a structure set forth above will be described below in detail. The silicon manufacturing method of the present embodiment mainly differs from the manufacturing method of the first embodiment in respect of features listed below. That is, in the first embodiment, the bottom plate 13 is removed from the reactor 10 to allow the peeling member to enter into the reactor 10 from the lower open end thereof, upon which polycrystalline silicon, accumulated in the depositing region S defined in the reactor 10 at the lower region of the inner surface wall thereof, is mechanically peeled off to collect polycrystalline silicon. In place of such a step, the manufacturing method of the present embodiment employs the step of supplying the stream of shock-blow gas through the shock-blow gas supply openings 200a to peel off polycrystalline silicon, accumulated in the depositing region S, for collection. Thus, the manufacturing method of the present embodiment substantially differs from the manufacturing method of the first embodiment in respect of the steps including the step of peeling off polycrystalline silicon deposited in the depositing region S and its subsequent steps, hence, description will be made with a focus on such a differing point.

In particular, the steam of inert gas is supplied into the reactor 10 with the valve 230a of the valve device 230 being closed for shutting off the inside of the reactor 10 from outside. Subsequently, the reduction reaction is continuously caused inside the reactor 10 for a predetermined time span for reducing silicon tetrachloride with zinc. Then, polycrystalline silicon with adequate thickness is accumulated in the depositing region S in the reactor 10 at the lower region of the inner wall surface thereof. When this takes place, the supplies of silicon tetrachloride gas and zinc gas are stopped. Then, the stream of inert gas is supplied into the reactor 10 from the inert gas supply opening 14a of the inert gas supply pipe 14 and the like such that atmosphere inside the reactor 10 is substituted by inert gas.

Subsequently, the step of applying the shock-blow is executed under a predetermined pressure, time span and cycle thorough the shock-blow gas supply opening 200a to impinge the stream of inert gas under high pressure upon the depositing region S inside the reactor 10. In this moment, polycrystalline silicon, accumulated in the depositing region S, is peeled off to drop downward under its own weight. When this takes place, since the valve 230a is closed with a view to shutting off the inside of the reactor 10 from the outside and, such dropped-off silicon is progressively accumulated on the valve 230a.

When the shock-blow step is terminated, the valve 230a is opened to cause polycrystalline silicon, accumulated on the valve 230a, to drop under its own weight into the silicon collection vessel 240. Thereafter, the valve 230a is closed again with a view to shutting off the inside of the reactor 10 form the outside. Meanwhile, polycrystalline silicon is taken out from the silicon collection vessel 240 for collection, upon which a series of steps of the silicon manufacturing method on current time is completed. Subsequently, a series of steps of the silicon manufacturing method on another time is continuously executed depending on needs. Here, since the silicon collection vessel 240 is detachably mounted on the silicon manufacturing apparatus 2, if the falling of silicon into the silicon collection vessel 240 is ended and after the valve 230a is turned to be closed, the silicon collection vessel 240 is removed from the silicon manufacturing apparatus 2 for delivery to a predetermined storage region, thereby making it possible to take polycrystalline silicon out form the silicon collection vessel 240 for collection.

In the structure of the present embodiment set forth above, the shock-blow gas is supplied into the reactor from the shock-blow gas supply opening. This results in a capability of peeling off silicon deposited in the silicon depositing region in the absence of direct contact with the inner wall surface of the reactor or the inner tube.

Further, the shock-blow gas supply opening is located below the silicon tetrachloride gas supply opening in the vertical direction. This makes it possible to allow shock-blow gas to surely impinge upon the silicon depositing region in a reliable manner, thereby reliably peeling silicon deposited in the silicon depositing region.

Further, silicon, peeled off from the silicon depositing region, drops downward into the silicon collection vessel, thereby enabling silicon to be reliably collected in the silicon collection vessel.

Furthermore, silicon, peeled off from the silicon depositing region, drops downward by its own weight to accumulate on the valve. Thus, opening the valve results in a effect of causing silicon to drop downward into the silicon collection vessel for collection. When this takes place, during the reduction reaction, the presence of the valve shuts off the inside of the reactor from outside such that the reduction reaction can be continuously and stably established while maintaining reaction environment at a high temperature. Subsequently, if a predetermined amount of silicon is accumulated on the valve when subjected to the shock-blow, then, the valve is opened to cause silicon to drop downward by its own weight into the silicon collection vessel at a normal temperature, after which the valve is closed for collecting silicon from the silicon collection vessel. Thus, silicon can be collected to allow a subsequent reaction to be executed without causing any contamination to the reactor, thereby making it possible to easily and reliably perform a stable continuous operation.

### Third Embodiment

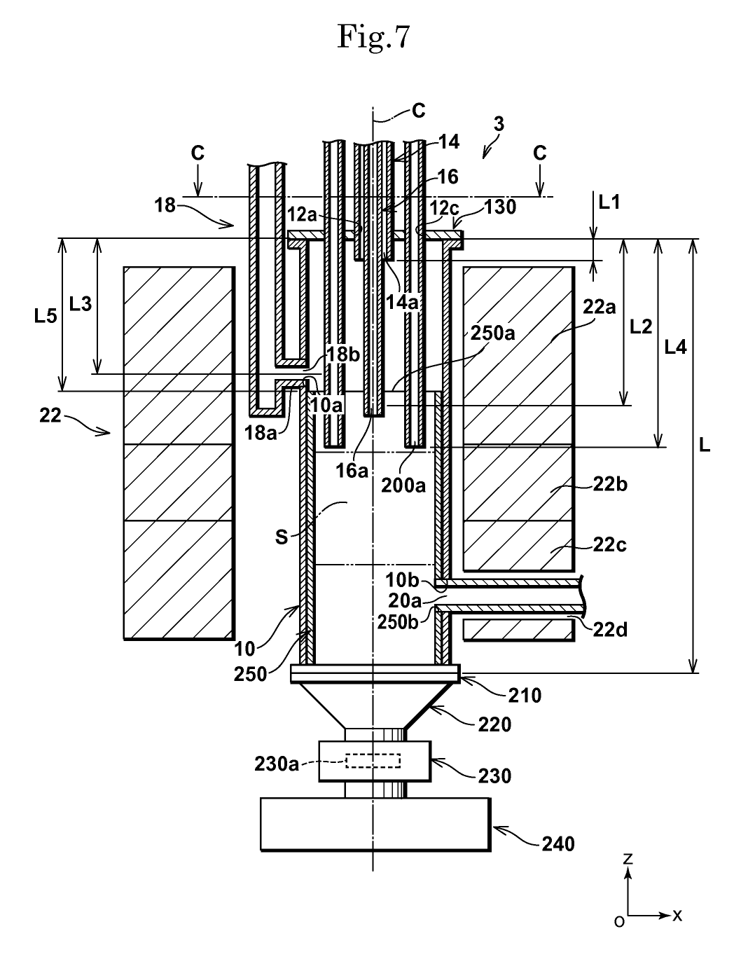

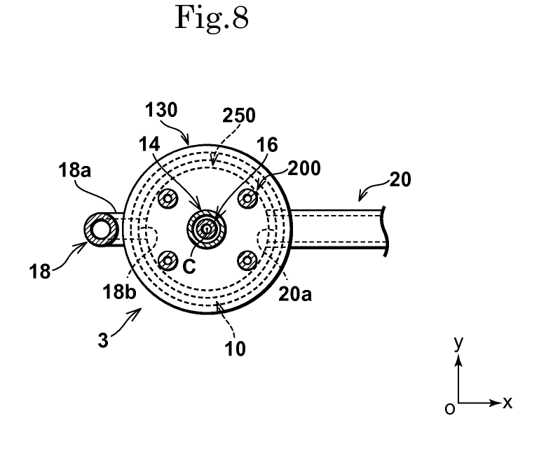

Next, a silicon manufacturing apparatus and its related method of a third embodiment will be described below in more detail with reference to FIGS. 7 and 8.

FIG. 7 is a schematic longitudinal cross-sectional view showing the silicon manufacturing apparatus of the present embodiment. Further, FIG. 8 is a schematic transverse cross-sectional view showing the silicon manufacturing apparatus of the present embodiment and corresponding to a cross section C-C of FIG. 7.

The silicon manufacturing apparatus 3 of the present embodiment mainly differs from the silicon manufacturing apparatus 2 of the second embodiment in that the silicon manufacturing apparatus 3 of the present embodiment is provided with the reactor 10 internally and additionally including an inner tube 250 whose inner wall surface has the depositing region S on which polycrystalline silicon is deposited, with remaining component parts being identical in structure. Therefore, the present embodiment will be described below with a focus on such a differing point with the same component parts bearing like reference numerals to suitably simplify or omit the relevant description.

As shown in FIGS. 7 and 8, in contrast to the structure of the silicon manufacturing apparatus 2 of the second embodiment, the silicon manufacturing apparatus 3 of the present embodiment further typically includes the cylindrical inner tube 250. The inner tube 250 is inserted to the reactor 10 along the inner wall of the reactor 10 in a coaxial relationship with the center axis C. Such an inner tube 250 is made of quartz glass and detachably mounted to the reactor 10.

In particular, the inner tube 250 has an upper end 250a, as an open end, located at a position distanced from the mating surface of the reactor 10 with respect to the upper lid 130 by a length of L5. That is, the position of the upper end 250a is determined to be lower than the zinc gas supply opening 18b of the zinc gas supply pipe 18 and higher than both of the silicon tetrachloride gas supply opening 16a of the silicon tetrachloride gas supply pipe 16 and the shock-blow gas supply openings 200a of the shock-blow gas supply pipe 200 (with L3<L5<L2<L4). Such a position of the upper end 250a is determined on concerns described below. In consideration of the possibility that silicon is deposited in a region substantially below the silicon tetrachloride gas supply opening 16a, the upper end 250a is to be preferably located above the silicon tetrachloride gas supply opening 16a. This allows a depositing region S to be reliably defined on the inner wall surface of the inner tube 250, while preventing silicon from depositing in a clearance between the inner tube 250a and the reactor 10. Also, with a view to precluding the undesired clogging of the zinc gas supply opening 18b with the upper end 250a, moreover, the upper end 250a is to be preferably located below the zinc gas supply opening 18b.

Further, the inner tube 250 is stable with a lower end portion thereof being supported by the connecting member 210 and, thus, the inner tube 250 extends downward beyond the exhaust gas pipe 20. Therefore, the inner tube 250 has an insertion hole 250b formed at a position corresponding to the insertion hole 10b of the reactor 100 without undesirably clogging the exhaust gas introduction opening 20a of the exhaust gas pipe 20. That is, the exhaust gas pipe 20 is inserted to both the insertion hole 10b, which is formed on the longitudinal wall of the reactor 10, and the insertion hole 250b, which is formed on the longitudinal wall of the inner tube 250, to be fixedly secured.

Furthermore, the inner tube 250 is heated and sustained by the second and third heating sections 22b and 22c of the heater 22 at the respective high temperatures in a range of 1000° C. or more and 1100° C. or less. Thus, if an outer wall surface of the inner tube 250 is held in contact with the inner wall surface of the reactor 10, the inner tube 250 and the reactor 10 are adhered to each other, with a resultant difficulty of dismounting of the inner tube 250. In view of such an occasion, the inner tube 250 is juxtaposed to be spaced form the reactor 10 with a predetermined clearance. In addition, in order to stably sustain such a clearance, a spacer, made of quartz glass, may be preferably interposed.

Besides, in the silicon manufacturing method of manufacturing polycrystalline silicon with the use of the silicon manufacturing apparatus 3 of such a structure mentioned above, polycrystalline silicon is accumulated in the depositing region S defined on an inner wall surface of the inner tube 250 during the reduction reaction step. Thereafter, in shock-blow step, polycrystalline silicon accumulated in the depositing region S is peeled from the inner wall surface of the inner tube 250 to allow polycrystalline silicon to accumulate on the valve 230a. Subsequently, the valve 230a is opened to cause silicon, accumulated on the valve 230a, to drop downward into the silicon collection vessel 240 for collection.

If a series of steps of such a silicon manufacturing method is repeatedly conducted many times, deterioration occurs on the inner wall surface of the inner tube 250. Therefore, the inner tube 250, used for the repetition cycles exceeding a predetermined reference number of times, is demounted from the reactor 10 for replacement with a new inner tube 250.

In such a structure of the present embodiment mentioned above, the silicon depositing region, defined on the inner wall surface of the inner tube detachably mounted inside the reactor, provides an increase in yield of silicon. In addition, the inner tube, with the inner wall surface subjected to deterioration, can be easily replaced with another one. This results in a capability of manufacturing silicon without a need to replace the reactor per se.

With the third embodiment, further, the inner tube 250 can be applied to the structure of the first embodiment having the bottom plate 13. With such an alternative, the inner tube 250 is fixedly secured to the bottom plate 13 with a lower end of the inner tube 250 being placed on the bottom plate 13. Thus, as the bottom plate 13 is dismounted from the reactor 10, the inner tube 250 can be dismounted from the reactor 10.

### Fourth Embodiment

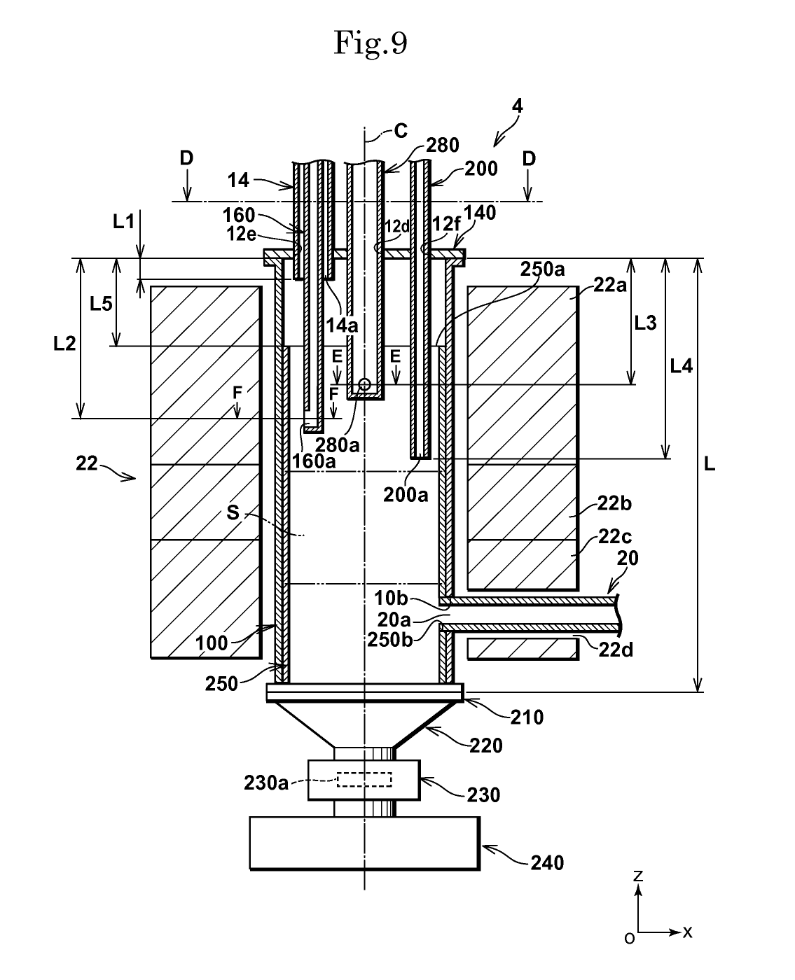

Next, a silicon manufacturing apparatus and its related method of a fourth embodiment will be described below in more detail with reference to FIGS. 9 to 11B.

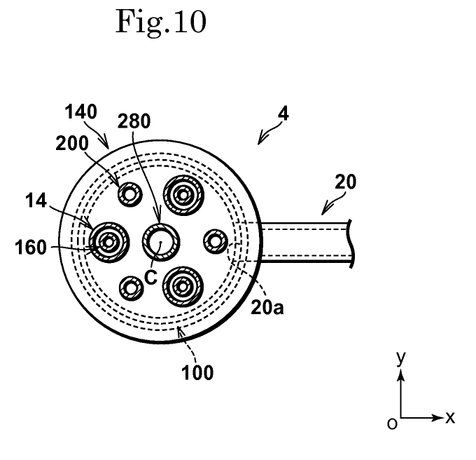

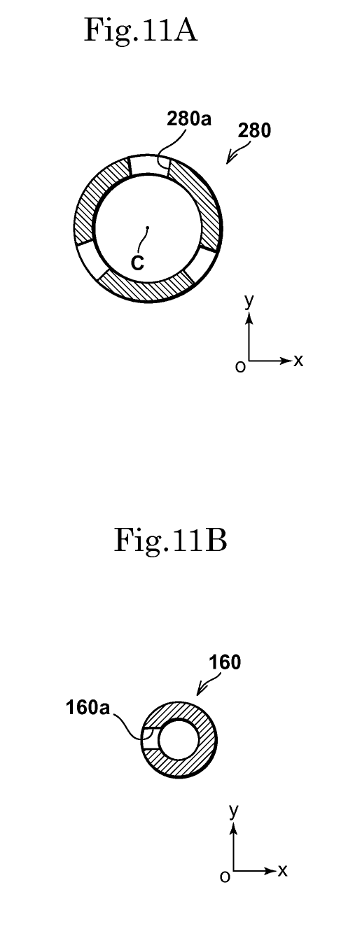

FIG. 9 is a schematic longitudinal cross-sectional view showing the silicon manufacturing apparatus of the present embodiment. FIG. 10 is a schematic transverse cross-sectional view showing the silicon manufacturing apparatus of the present embodiment and corresponding to a cross section D-D of FIG. 9. FIG. 11A is a schematic, transverse enlarged cross-sectional view of a zinc gas supply pipe incorporated in the silicon manufacturing apparatus of the present embodiment and corresponds to a cross section taken on a plane E-E of FIG. 9. Also, FIG. 11B is a schematic, transverse enlarged cross-sectional view of a silicon tetrachloride gas supply pipe incorporated in the silicon manufacturing apparatus of the present embodiment and corresponds to a cross section taken on a plane F-F of FIG. 9.

The silicon manufacturing apparatus 4 of the present embodiment mainly differs from the silicon manufacturing apparatus 3 of the third embodiment in that no insertion hole 10a is formed on the longitudinal wall of the reactor 100 and the reactor 100 has an upper lid 140, made of quartz glass to close an upper open end of the reactor 100 and having a central region to which a zinc gas supply pipe 280 is inserted, and with respect to the upper lid 140, there are provided each inert gas supply pipe 14, which encompasses a silicon tetrachloride gas supply pipe 160, and each shock-blow gas supply pipe 200, both adjacent to the zinc gas supply pipe 280, with remaining component parts being identical in structure. Therefore, the present embodiment will be described below with a focus on such a differing point with the same component parts bearing like reference numerals to suitably simplify or omit the relevant description.

As shown in FIGS. 9 and 10, the reactor 100, made of quartz glass, is identical to the structure of the modified form of the first embodiment shown in FIGS. 4A to 4C and has a structure in which the connecting portion 18a, to which the zinc gas supply pipe 18 is inserted, is omitted from the longitudinal wall of the reactor 10 shown in FIGS. 1 and 2, i.e., a structure that has no connecting portion 18a.

The upper lid 140, made of quartz glass to close an upper open end of the reactor 100, has one piece of insertion hole 12d, formed in a coaxial relationship with the center axis C, a plurality of insertion holes 12e and another plurality of insertion holes 12f, with the insertion holes 12e and the insertion holes 12f being respectively formed in portions adjacent to the insertion hole 12d.

One piece of zinc gas supply pipe 280, made of quartz glass, is inserted to the insertion hole 12d in communication with the zinc gas supply source, which is not shown. The zinc gas supply pipe 280 enters into the inside of the reactor 100 to vertically extend downward in a coaxial relationship with the center axis C. In addition, the zinc gas supply pipe 280 has a zinc gas supply opening 280a that is opened at a lower end of the longitudinal wall of the zinc gas supply pipe 280, with a vertically lowest distal end of such a longitudinal wall being closed.

The plural insertion holes 12e are typically formed in three portions of the upper lid 140 at with equally spaced intervals of 120° in a circumferential direction of the upper lid 140 to be equidistant from the center axis C, respectively. One piece of inert gas supply pipe 14, made of quartz glass, is inserted and fixedly secured to each insertion hole 12e in communication with the inert gas supply source, which is not shown. Moreover, each inert gas supply pipe 14 internally incorporates one piece of silicon tetrachloride gas supply pipe 160, made of quartz glass, in communication with the silicon tetrachloride gas supply source, which is not shown. Each silicon tetrachloride gas supply pipe 160 has a silicon tetrachloride gas supply opening 160a that is opened at a lower end of the longitudinal wall of the silicon tetrachloride gas supply pipe 160, with a vertically lowest distal end of such a longitudinal wall being closed.

The plural insertion holes 12f are typically formed in three portions of the upper lid 140 at equally spaced intervals of 120° in the circumferential direction of the upper lid 140 to be equidistant from the center axis C, respectively. One piece of shock-blow gas supply pipe 200, made of quartz glass, is inserted and fixedly secured to each insertion hole 12f in communication with the inert gas supply source, which is not shown.

As described above, there is provided to insert one piece of zinc gas supply pipe 280 through the central region of the upper lid 140 such that it extends into the reactor 100 and also dispose the silicon tetrachloride gas supply pipes 160, encompassed in the plural inert gas supply pipe 14, respectively, around the zinc gas supply pipe 280. The reason for adopting such a structure is due to in consideration of a structural convenience as stated below in more detail. That is, zinc, which has the boiling point of 910° C., needs to be introduced into the reactor 100 while heated to a temperature higher than that of silicon tetrachloride gas, which has the boiling point of 59° C. Although this results in tendency of causing the reactor 100 and the upper lid 140 to have slightly increasing diameters, such a structure enables zinc gas, maintained at a relatively high temperature, to be collectively introduced into the central region of the reactor 100 in a radial direction thereof, while enabling silicon tetrachloride gas to be dispersively introduced into the reactor 100 around such a central region, in a reliable fashion, with an entire apparatus being designed in a further compact structure. In addition, under a circumstance where the reactor 100 and the upper lid 140 can be manufactured in further increasing diameters in size, it doesn't matter if a plurality of zinc gas supply pipes 280 is provided.

The inert gas supply openings 14a of the inert gas supply pipes 14, the silicon tetrachloride gas supply openings 160a of the silicon tetrachloride gas supply pipes 160, the zinc gas supply opening 280a of the zinc gas supply pipe 280 and the shock-blow gas supply openings 200a of the shock-blow gas supply pipes 200 are opened at positions spaced from the mating surface of the reactor 100 with respect to the upper lid 140 by lengths of L1, L2, L3 and L4, respectively. Also, the inner tube 250 has the upper end 250a located at a position spaced from the mating surface of the reactor 100 with respect to the upper lid 140 by a length of L5. Here, these lengths have the relationship of L1<L5<L3<L2<L4.

That is, the inert gas supply openings 14a of the inert gas supply pipes 14 has an opening position located above the upper end 250a of the inner tube 250. Meanwhile, the silicon tetrachloride gas supply openings 160a of the silicon tetrachloride gas supply pipes 160, the zinc gas supply opening 280a of the zinc gas supply pipe 280 and the shock-blow gas supply openings 200a of the shock-blow gas supply pipes 200 have respective opening positions located below the upper end 250a of the inner tube 250. Simultaneously, the zinc gas supply opening 280a has an opening position located above the silicon tetrachloride gas supply openings 160a.

Thus, in such a structure, not only the opening position of the silicon tetrachloride gas supply openings 160a of the silicon tetrachloride gas supply pipes 160 but also the opening position of the zinc gas supply opening 280a of the zinc gas supply pipe 280 are both located below the upper end 250a of the inner tube 250. The reason for adopting such a structure is stated below in more detail. That is, with the provision of the structure in which the zinc gas supply pipe 280 is inserted through the central region of the upper lid 140 so as to extend into the reactor 100, the zinc gas supply opening 280a can be located in the lower region of the reactor 100 in a simplified structure without causing the insertion hole to be formed on the longitudinal wall of the inner tube 250. The presence of not only silicon tetrachloride gas but also zinc gas available to be ejected into the inner tube 250 results in a capability of reliably suppressing the phenomenon of causing such gases to undesirably and dispersively enter the clearance between an inner surface of the longitudinal wall of the reactor 100 and an outer surface of the longitudinal wall of the inner tube 250.

As shown in FIG. 11A, further, the zinc gas supply pipe 280 may preferably have a plurality of zinc gas supply openings 280a and in such structure, the zinc gas supply pipe 280 has a longitudinal wall whose lower end is typically formed with three pieces of zinc gas supply openings 280a at equally spaced intervals of 120° in axial symmetry with respect to the center axis C. This is because zinc gas is ejected horizontally in the inside of the reactor 100 to be reliably and uniformly dispersed with a preferably increased effect of mixing between zinc gas and silicon tetrachloride gas. Under a circumstance where zinc gas and silicon tetrachloride gas are preferably mixed to each other, of course, a single piece of the zinc gas supply opening 280a of the zinc gas supply pipe 280 may be provided and, in an alternative, the zinc gas supply pipe 280 may have a lowest distal end in a vertical direction that is opened.

As shown in FIG. 11B, further, it may suffice for the silicon tetrachloride gas supply openings 160a to be formed on the longitudinal wall of the silicon tetrachloride gas supply pipe 160 at a lower end of such a longitudinal wall in arbitrary locations with an arbitrary number of pieces (with an example shown in the figure with only one piece of opening being formed in opposition to the inner wall of the inner tube 250). This is because it suffices for silicon tetrachloride gas to be just horizontally ejected in view of preferable mixing capability between zinc gas and silicon tetrachloride gas.

Besides, in the silicon manufacturing method of manufacturing polycrystalline silicon with the use of the silicon manufacturing apparatus 4 of such a structure set forth above, polycrystalline silicon is accumulated in the depositing region S defined on the inner wall surface of the inner tube 250 during the reduction reaction step. Thereafter, in shock-blow step, polycrystalline silicon accumulated in the depositing region S is peeled from the inner wall surface of the inner tube 250 to allow polycrystalline silicon to accumulate on the valve 230a. Subsequently, the valve 230a is opened to cause silicon, accumulated in such a way, to drop downward into the silicon collection vessel 240 for collection. In addition, a series of steps of such a silicon manufacturing method is repeatedly conducted many times. When the number of such repetition cycles exceeds a predetermined reference number of times, then, the inner tube 250 is dismounted from the reactor 100 for replacement with a new inner tube 250.

In such a structure of the present embodiment mentioned above, the reactor has the cylindrical shape and the zinc gas supply pipe is connected to the inside of the reactor through the upper lid thereof so as to extend in the vertical direction in a coaxial relationship with the center axis of the reactor. This enables the apparatus to be formed in a further compact structure that makes it possible to collectively and reliably introduce zinc gas, needed to be maintained at a high temperature, due to its relatively high boiling temperature, and normally needed to have a large volume of gas, into the central region of the reactor in a radial direction thereof, while enabling silicon tetrachloride gas to be dispersively introduced into the reactor around such a central region, in a reliable fashion. Such a compact structure is also able to cause the reduction reaction to occur in a further increased effect for reducing silicon tetrachloride gas with zinc gas for manufacturing polycrystalline silicon with an increase in yield.

Further, the silicon tetrachloride gas supply opening and the zinc gas supply opening are located below the upper end of the inner tube in the vertical direction. This causes silicon tetrachloride gas and zinc gas to be surely dispersed in a mixed state, effectively suppressing these gases from undesirably intruding a space between the inner longitudinal wall of the reactor and the outer longitudinal wall of the inner tuber. This results in a consequence of efficiently achieving the reduction reaction to reduce silicon tetrachloride with zinc for enabling the production of silicon with increased yield.

Furthermore, it is of course to be understood that the arrangement structures of the zinc gas supply pipe 280 and the inert gas supply pipes 14 encompassing the respective silicon tetrachloride gas supply pipes 160 of the fourth embodiment can be applied to the structures of the first and second embodiments.

Moreover, with the various embodiments set forth above, various component parts such as the reactor, the upper lid, the bottom plate, the inert gas supply pipe, the silicon tetrachloride gas supply pipe, the zinc gas supply pipe, the exhaust gas pipe, the shock-blow gas supply pipe, the inner tube and the like need to be made of materials that can fully withstand raw materials such as silicon tetrachloride gas and zinc gas, as well as zinc chloride gas produced as byproduct, respectively at a temperature as high as 950° C. Thus, examples of these materials may include quartz glass, silicon carbide and silicon nitride, etc. However, with a view to avoiding the contamination of resulting silicon with carbon and nitrogen, quartz, i.e., quartz glass may be mostly preferred.

Further, with the various embodiments set forth above, an example of inert gas may include noble gases such as He gas, Ne gas, Ar gas, Kr gas, Xe gas and Rn gas, and nitrogen gas, etc. With a view to avoiding nitrogen from entering deposited silicon, noble gas may be preferably employed and, among noble gases, Ar gas may be mostly preferred because of its low cost.

Besides, several examples of various embodiments set forth above will be described below in more detail.

### Example 1

In present examples, polycrystalline silicon was manufactured using the silicon manufacturing apparatus 1 of the first embodiment.

With the silicon manufacturing apparatus 1 of the first embodiment, more particularly, the reactor 10, made of quartz glass, had an outer diameter D of 56 mm (with a wall thickness of 2 mm and an inner diameter of 52 mm) in a length L of 2050 mm. The inert gas supply pipe 14, made of quartz glass, had an outer diameter of 16 mm (with a wall thickness of 1 mm and an inner diameter of 14 mm). The inert gas supply opening 14a had an opening position (representing a position of the distal end portion of the inert gas supply pipe 14 in the reactor 10) that was set to be distanced from the mating surface of the reactor 10 with respect to the upper lid 12 by a length L1 of 10 mm. The silicon tetrachloride gas supply pipe 16 was made of quartz glass with an outer diameter of 9 mm (with a wall thickness of 1 mm and an inner diameter of 7 mm). The silicon tetrachloride gas supply opening 16a had an opening position (representing the position of the distal end portion of the silicon tetrachloride gas supply pipe 16 in the reactor 10) that was set to be spaced from the mating surface of the reactor 10 with respect to the upper lid 12 by a length L2 of 750 mm. The zinc gas supply pipe 18, made of quartz glass, had an outer diameter of 20 mm (with a wall thickness of 2 mm and an inner diameter of 16 mm). The zinc gas supply opening 18b had an opening position (representing the position of the distal end portion of the zinc gas supply pipe 18 in the reactor 10) that was set to be spaced from the mating surface of the reactor 10 with respect to the upper lid 12 by a length L3 of 550 mm. The exhaust gas pipe 20, made of quartz glass and having the exhaust gas introduction opening 20a, had an outer diameter of 56 mm (with a wall thickness of 2 mm and an inner diameter of 52 mm).

With the detailed structure set forth above, first, each stream of Ar gas was ejected into the reactor 10 from the inert gas supply opening 14a of the inert gas supply pipe 14 at a flow rate of 1.56 SLM, the silicon tetrachloride gas supply opening 16a of the silicon tetrachloride gas supply pipe 16 at a flow rate of 0.50 SLM, and the zinc gas supply opening 18b of the zinc gas supply pipe 18 at a flow rate of 2.04 SLM (with a total flow rate of 4.10 SLM).

Under a circumstance where Ar gas was supplied into the reactor 10 in such a way, subsequently, the heater 22 was energized. This caused the first heating section 22a to heat the relevant longitudinal wall and the relevant region of the inside of the reactor 10 so as to be raised at a temperature of 1200° C. The second heating section 22b heated the relevant longitudinal wall and the relevant region of the inside of the reactor 10 at a temperature of 1100° C. The third heating section 22c heated the relevant longitudinal wall and the relevant region of the inside of the reactor 10 at a temperature of 1000° C.

With the heater 22 energized in such a way, the first heating section 22a, the second heating section 22b and the third heating section 22c remained operative to heat the relevant longitudinal walls and the relevant regions of the inside of the reactor 10 to be maintained at the respective temperatures. Under such states, a zinc wire was introduced to the zinc gas supply pipe 18 at a feed rate of 1.93 g/min to gasify the same with a view to supplying not only Ar gas but also zinc gas to the zinc gas supply pipe 18. This allowed zinc gas to be mixed with Ar gas, with such mixed gas being ejected from the zinc gas supply opening 18b into the reactor 10 at a flow rate of 2.04 SLM. Simultaneously, Ar gas, prevailing in the silicon tetrachloride gas supply pipe 16, was substituted by silicon tetrachloride gas, and such silicon tetrachloride gas was ejected from the silicon tetrachloride gas supply opening 16a into the reactor 10 at a flow rate of 0.33 SLM, with the inert gas supply opening 14a of the inert gas supply pipe 14 ejecting Ar gas into the reactor 10 at the flow rate of 1.56 SLM, thereby initiating a reduction reaction for 15 minutes.

After such a reduction reaction continued for 15 minutes, the supply of reaction feed materials in the form of silicon tetrachloride gas and zinc gas was stopped and the heater 22 was turned off, with only inert gas being supplied to the reactor 10 through the inert gas supply opening 14a of the inert gas supply pipe 14 and the like. Under such a condition, remnant silicon tetrachloride gas and zinc gas as well as byproduct of zinc chloride gas were exhausted, upon which the cooling of the reactor 10 was effectuated to a normal temperature.

Subsequently, the bottom plate 13 was dismounted from the reactor 10 and the inner wall surface of the reactor 10 was observed. Then, the existence of a deposition layer was confirmed to be present on the inner wall surface of the reactor 10 in a region defined between an upper portion downwardly spaced from the opening position of the silicon tetrachloride gas supply opening 16a (the distal end position of the silicon tetrachloride gas supply pipe 16) by about 400 mm and a lower position directly above a vicinity of the exhaust gas opening 20a. Such a deposition layer could be peeled off using a peeling member. Upon observing the peeled-off product, it was acicular polycrystalline silicon.

### Example 2

With the present example, the silicon manufacturing apparatus 2 of the second embodiment was used to manufacture polycrystalline silicon.

With the silicon manufacturing apparatus 2, more particularly, the reactor 10, the inert gas supply pipe 14, the silicon tetrachloride gas supply pipe 16, the zinc gas supply pipe 18, the exhaust gas pipe 20 and the heater 22 took the same structures as those of the silicon manufacturing apparatus 1 used in the example 1. Various steps of a process of reducing silicon tetrachloride gas with zinc gas was conducted to achieve a reduction reaction upon supplying Ar gas into the reactor 10, with the longitudinal wall and the inside of the reactor 10 being heated and maintained by the heater 22 were conducted in the same manner as those of the example 1. However, the silicon manufacturing apparatus 2, used in the present example, was of the type in which shock-blow gas was supplied with differences in related structures and related steps.

That is, each of four pieces of shock-blow gas supply pipes 200, made of quartz glass and provided in an axial symmetry with respect to the center axis C, had an outer diameter of 6 mm (with a wall thickness of 1 mm and an inner diameter of 4 mm). In addition, each of the shock-blow gas supply openings 200a had an opening position (at a distal end position of the shock-blow gas supply pipe 200 in the reactor 10) that was set to be spaced from the mating surface of the reactor 10 with respect to the upper lid 130 by a length of L4 of 1050 mm.

With the detailed structure set forth above, to shut off the inside of the reactor 10 from outside, the valve 230a of the valve device 230 was closed. Under such a state, a stream of Ar gas was supplied into the reactor 10 and the heater 22 was energized to sustain the longitudinal wall and the inside of the reactor 10 in heated states. Thereafter, a reduction reaction was conducted for reducing silicon tetrachloride gas with zinc. Under such a condition remained in the heating state, both the introduction of the zinc wire into the zinc gas supply pipe 18 and the supply of silicon tetrachloride gas into the silicon tetrachloride gas supply pipe 16 were stopped. Subsequently, Ar gas was ejected from the inert gas supply opening 14a of the inert gas supply pipe 14 into the reactor 10 at a flow rate of 1.56 SLM; Ar gas was ejected from the silicon tetrachloride gas supply opening 16a of the silicon tetrachloride gas supply pipe 16 into the reactor 10 at a flow rate of 0.50 SLM; and Ar gas was ejected from the zinc gas supply opening 18b of the zinc gas supply pipe 18 into the reactor 10 at a flow rate of 2.04 SLM, again. This allowed the inside gases of the reactor 10 to be substituted by Ar gas for 5 minutes.

After the substitution was completed with Ar gas, then, Ar gas was ejected from the shock-blow gas supply openings 200a of the shock-blow gas supply pipe 200 under a high pressure, thereby achieving the shock-blow. In this moment, the shock-blow was conducted under a condition in which Ar gas was maintained under a pressure of 0.4 MPa; a time span for one shock-blow was set to a value of 0.5 seconds; an interval to a subsequent shock-blow was set to a value of 3.0 seconds; and the shock-blow was executed in a total sum of 20 times.

Then, there was repeatedly conducted in a total sum of 4 times in series of steps including the reaction continued for 15 minutes, the substitution with Ar gas for 5 minutes and the shock-blow repeatedly executed in the total sum of 20 times, sequentially. Subsequently, the valve 230a of the valve device 230 connected to the reactor 10 at the lower portion thereof was opened, causing deposition substance to drop off from the valve 230a into the silicon collection vessel 240. Upon observing such collected substance in the silicon collection vessel 240, the collected substance was confirmed to be acicular polycrystalline silicon. It was considered that silicon was deposited on the inner wall surface of the reactor 10 and peeled off by application of the shock-blow to allow the deposition substance to accumulate on the valve 230a of the valve device 230 with such deposition substance being collected. In addition, upon weighing such acicular polycrystalline silicon, it weighed 8.7 g, with a resultant reaction rate of silicon tetrachloride gas, subjected to the reduction reaction, being 35%.

### Third Example

The present example is similar to the example 2 in that polycrystalline silicon was manufactured using the silicon manufacturing apparatus 2 of the second embodiment but differs in other respects described below. Specifically, in contrast to the structure employed in the example 2, the shock-blow gas supply pipe 200 was shortened in length such that the shock-blow gas supply opening 200a had an opening position (a distal end position of the shock-blow gas supply pipe 200 in the reactor 10) spaced from the mating surface of the reactor 10 with respect to the upper lid 130 by a length of L4 of 800 mm; the flow rate of Ar gas supplied from the inert gas supply opening 14a of the inert gas supply pipe 14 was set to a value of 0.12 SLM; a time span of the reduction reaction was set to a value of 30 minutes; and there was repeatedly conducted in a total sum of 2 times in series of steps including the reduction reaction continued for 30 minutes, the substitution with Ar gas for 5 minutes and the shock-blow with Ar gas repeatedly executed in the total sum of 20 times, sequentially.

With such a detailed structure mentioned above, the series of steps was carried out and, then, deposition substance on the valve 230a of the valve device 230 was caused to drop off into the silicon collection vessel 240. Upon observing such collected substance in the silicon collection vessel 240, it was confirmed to be acicular polycrystalline silicon. In addition, upon weighing such acicular polycrystalline silicon, it weighed 11.1 g, with a resultant reaction rate of silicon tetrachloride gas, subjected to the reduction reaction, being 45%.

### Fourth Example

The present example is similar to the example 3 in that polycrystalline silicon was manufactured using the silicon manufacturing apparatus 2 of the second embodiment but differs in other respects described below. Specifically, in contrast to the structure employed in the example 3, no Ar gas is supplied from the inert gas supply opening 14a of the inert gas supply pipe 14; the flow rate of silicon tetrachloride gas, supplied from the silicon tetrachloride gas supply opening 16a of the silicon tetrachloride gas supply pipe 16, was set to a value of 0.66 SLM; the flow rate of Ar gas, supplied form the zinc gas supply opening 18b of the zinc gas supply pipe 18, was set to a value of 0.22 SLM; the feed rate of the zinc wire, introduced into the zinc gas supply pipe 18 with a view to supplying Ar gas and in addition thereto zinc gas, was set to a value of 3.85 g/min for gasification; and there was repeatedly conducted in a total sum of 4 times in series of steps including the reaction continued for 15 minutes, the substitution with Ar gas for 5 minutes and the shock-blow repeatedly executed in the total sum of 20 times, sequentially.

With such a detailed structure mentioned above, the series of steps was carried out and, then, deposition substance was caused to drop off from the valve 230a of the valve device 230 into the silicon collection vessel 240. Upon observing such collected substance in the silicon collection vessel 240, it was confirmed to be acicular polycrystalline silicon. In addition, upon weighing such acicular polycrystalline silicon, it weighed 29.7 g, with a resultant reaction rate of silicon tetrachloride gas, subjected to the reduction reaction, being 60%.

### Fifth to Seventh Examples

With the present examples, under the conditions of the second to fourth examples, a series of steps was carried out for manufacturing polycrystalline silicon using the silicon manufacturing apparatus 3 of the third embodiment. Deposition substance was caused to drop off from the valve 230a of the valve device 230 into the silicon collection vessel 240. Upon observing such collected substance in the silicon collection vessel 240, it was confirmed to be acicular polycrystalline silicon, whose collection yield resulted in the same value as those of the second to fourth examples. This was considered to derive from the fact that polycrystalline silicon was deposited on the inner wall surface of the inner tube 250 mounted in the reactor 10 after which such deposited polycrystalline silicon was peeled off to accumulate on the valve 230a of the valve device 230 and then collected.

### Eighth Example

With the present example, polycrystalline silicon was manufactured using the silicon manufacturing apparatus 4 of the fourth embodiment.

With the silicon manufacturing apparatus 4, more particularly, the outer diameter D of the reactor 100, made of quartz glass, was set to 226 mm (with a wall thickness of 3 mm and an inner diameter of 220 mm) in a length L of 2330 mm. The outer diameter of the inner tube 250, made of quartz glass, was set to 206 mm (with a wall thickness of 3 mm and an inner diameter of 200 mm) with the distal end 250a being spaced from the mating surface of the reactor 100 with respect to the upper lid 140 by a length L5 of 50 mm. The outer diameter of the zinc gas supply pipe 280, made of quartz glass, was set to 42 mm (with a wall thickness of 3 mm and an inner diameter of 36 mm). Such a zinc gas supply pipe 280 had a bottom end closed, with only a longitudinal wall thereof was formed with three zinc gas supply openings 280a, formed around the center axis C at circumferentially and equally spaced intervals by an angle of 120°, whose diameters were set to be 16 mm and opening positions (center positions of the openings) were set to be spaced from the mating surface of the reactor 100 with respect to the upper lid 140 by a length L3 of 300 mm. The outer diameter of the exhaust gas pipe 20, made of quartz glass and having the exhaust gas introduction opening 20a connected to the reactor 100 at the lower portion thereof, was set to 56 mm (with a wall thickness of 2 mm and an inner diameter of 52 mm).

Further, three inert gas supply pipes 14, made of quartz glass, and three silicon tetrachloride gas supply pipes 160, made of quartz glass and correspondingly incorporated inside the inert gas supply pipes 14, were mounted in positions spaced from the center axis C by a distance of 85 mm at equally spaced intervals of 120°. The shock-blow gas supply pipes 200, made of quartz glass, were mounted in positions, spaced from the center axis C by a distance of 85 mm at equally spaced intervals of 120°, with the three inert gas supply pipes 14 being correspondingly intervened therebetween.

An outer diameter of each inert gas supply pipe 14 was set to 16 mm (with a wall thickness of 1 mm and an inner diameter of 14 mm). The opening position (located at the distal end position of the inert gas supply pipe 14 in the reactor 100) of the inert gas supply opening 14a was set to be spaced from the mating surface of the reactor 100 with respect to the upper lid 140 by a length L1 of 10 mm. The outer diameter of the silicon tetrachloride gas supply pipe 160 was set to 9 mm (with a wall thickness of 1 mm and an inner diameter of 7 mm). A lower end of each silicon tetrachloride gas supply pipe 160 was closed and only a longitudinal wall thereof was formed with one silicon tetrachloride gas supply opening 160a, which opened so as to face the inner wall surface of the inner tube 250 at a position (a center position of the opening) spaced from the mating surface of the reactor 100 with respect to the upper lid 140 by a length L2 of 500 mm. The outer diameter of each shock-blow gas supply pipe 200 was set to 9 mm (with a wall thickness of 1 mm and an inner diameter of 7 mm). The opening position (located at the distal end position of each shock-blow gas supply pipe 200 in the reactor 100) of each shock-blow gas supply opening 200a was set to be spaced from the mating surface of the reactor 100 with respect to the upper lid 140 by a length L4 of 600 mm.

With the detailed structure set forth above, to shut off the inside of the reactor 100 from outside, the valve 230a of the valve device 230 was closed. Under such a state, Ar gas was ejected from the inert gas supply opening 14a of the inert gas supply pipe 14 into the reactor 100 at a flow rate of 0.83 SLM; Ar gas was ejected from the silicon tetrachloride gas supply opening 160a of the silicon tetrachloride gas supply pipe 160 into the reactor 100 at a flow rate of 1.00 SLM; and Ar gas was ejected from the zinc gas supply opening 280b of the zinc gas supply pipe 280 into the reactor 100 at a flow rate of 0.84 SLM, with Ar gas having a total flow rate of 2.67 SLM.

With the reactor 100 being supplied with Ar gas, next, the heater 22 was energized in such a manner that the first heating section 22a raised the temperatures of the relevant longitudinal wall and the relevant inside of the reactor 100 to be maintained at 1200° C. The second heating section 22b raised the temperatures of the relevant longitudinal wall and the relevant inside of the reactor 100 to be maintained at 1100° C. And, the third heating section 22c raised the temperatures of the relevant longitudinal wall and the relevant inside of the reactor 100 to be maintained at 1000° C.

Under a circumstance where the heater 22 was energized to cause the first to third heating sections 22a to 22c to respectively heat the relevant regions of the longitudinal wall and the inside of the reactor 100 to be maintained at the respective high temperatures, subsequently, zinc gas was mixed to Ar gas at a flow rate of 10.00 SLM with such mixed gas being ejected from the zinc gas supply opening 280b of the zinc gas supply pipe 280 into the reactor 100 at a flow rate of 10.84 SLM. Subsequently, the stream of gas in the silicon tetrachloride gas supply pipe 160 was switched from Ar gas to silicon tetrachloride gas while Ar gas was ejected again from the inert gas supply opening 14a of the inert gas supply pipe 14 into the reactor 100 at a flow rate of 0.83 SLM. In this moment, silicon tetrachloride gas was ejected from the silicon tetrachloride gas supply opening 160a of the silicon tetrachloride gas supply pipe 160 into the reactor 100 at a flow rate of 5.00 SLM, upon which the reduction reaction was continued for 100 minutes.

After the reduction reaction was continued for 100 minutes, the supply of reaction feed materials in the form of silicon tetrachloride gas and zinc gas was stopped with the heater 22 remained turned on. Thereafter, Ar gas was ejected again from the inert gas supply opening 14a of the inert gas supply pipe 14 into the reactor 100 at a flow rate of 2.00 SLM; Ar gas was ejected from the silicon tetrachloride gas supply opening 160a of the silicon tetrachloride gas supply pipe 160 into the reactor 10 at a flow rate of 2.00 SLM; and Ar gas was ejected from the zinc gas supply opening 280b of the zinc gas supply pipe 280 at a flow rate of 2.00 SLM, whereby the inside gas of the reactor 100 to be substituted with Ar gas for 5 minutes.

After the substitution with Ar gas was completed, next, Ar gas was ejected from the shock-blow gas supply openings 200a of the shock-blow gas supply pipe 200 under a high pressure, thereby executing the shock-blow. In this moment, the shock-blow was conducted under a condition, in which the pressure of Ar gas was set to 0.4 MPa and a time span of the shock-blow for one cycle was set to 0.5 seconds while a time interval for a subsequent shock-blow was set to 3.0 seconds, and the shock-blow was conducted in a total sum of 15 times.

Here, there was repeatedly conducted in a total sum of 2 times in series of steps including the reaction continued for 100 minutes, the substitution with Ar gas for 5 minutes and the shock-blow repeatedly executed in the total sum of 15 times, sequentially. Subsequently, the valve 230a of the valve device 230, connected to the reactor 100 at the lower portion thereof, was opened, thereby causing deposition substance to drop off from the valve 230a into the silicon collection vessel 240. Upon observing such collected substance in the silicon collection vessel 240, it was confirmed to be acicular polycrystalline silicon. It was considered that silicon was deposited on the inner wall surface of the inner tube 250 mounted in the reactor 100 and peeled off by application of the shock-blow to allow the deposition substance to accumulate on the valve 230a of the valve device 230 with such deposition substance being collected. In addition, upon weighing such acicular polycrystalline silicon, it weighed 619.8 g, with a resultant reaction rate of silicon tetrachloride gas, subjected to the reduction reaction, being 50%.

With such various examples set forth above, it could be confirmed that silicon was deposited on the inner wall surfaces of the reactors 10 and 100 or the inner wall surfaces of the inner tubes 250 mounted inside the reactors 10 and 100 in a polycrystalline state. With the examples 2 to 8, further, it was confirmed that silicon, deposited on the inner wall surfaces of the reactors 10 and 100 or and the inner wall surfaces of the inner tubes 250 mounted inside the reactors 10 and 100 could be peeled off by the shock-blow to allow silicon to be collected in the silicon collection vessel 240 through the valve 230a of the valve device 230.

Moreover, in the present invention, it is of course to be noted that a kind of component parts, a layout of the same, the number of pieces of the same and the like are not limited to those of the embodiments set forth above and, also, the component parts may be suitably replaced with those exhibiting equivalent advantageous effects in appropriate alternatives, without departing the scope of the present invention.

### INDUSTRIAL APPLICABILITY

As set forth above, the present invention can provide a silicon manufacturing apparatus and a silicon manufacturing method, with scalability to enable the realization of such a structure that can produce polycrystalline silicon with increased yield at low cost whereby it becomes possible to continuously and efficiently produce polycrystalline silicon for collection, which can be expected to be widely applied to manufacturing apparatuses for solar cell grade silicon or the like in view of all-purpose and universal characters.

1. A silicon manufacturing apparatus comprising:
a reactor standing upright in a vertical direction;
a silicon tetrachloride gas supply pipe connected to the reactor and having a silicon tetrachloride gas opening through which a silicon tetrachloride gas is supplied to the reactor;
a zinc gas supply pipe connected to the reactor and having a zinc gas supply opening through which a zinc gas is supplied to the reactor; and
a heater that heats the reactor,
wherein the zinc gas supply opening is placed above the silicon tetrachloride gas opening in the vertical direction,
and wherein the heater heats a part of the reactor at a temperature lying in a silicon depositing temperature range during which silicon tetrachloride gas is supplied from the silicon tetrachloride gas opening to the reactor to which zinc gas is supplied from the zinc gas supply opening, whereby silicon tetrachloride is reduced with zinc in the reactor to form a silicon depositing region, in which silicon is deposited on a wall portion in the reactor corresponding to a region thereof that is set to the silicon depositing temperature range.

2. The silicon manufacturing apparatus according to claim 1, wherein the silicon depositing region is an inner wall surface of the reactor corresponding to the region thereof that is set to the silicon depositing temperature range.

3. The silicon manufacturing apparatus according to claim 1, further comprising an inner tube detachably mounted inside the reactor, wherein the silicon depositing region is an inner wall surface of the inner tube mounted inside the reactor corresponding to the region thereof that is set to the silicon depositing temperature range.

4. The silicon manufacturing apparatus according to claim 3, wherein the silicon tetrachloride gas opening and the zinc gas supply opening are placed below an upper end of the inner tube in the vertical direction.

5. The silicon manufacturing apparatus according to claim 1, further comprising a shock-blow gas supply pipe having a shock-blow gas supply opening connected to the reactor that supplies a shock-blow gas thereto under which the shock-blow gas is supplied from the shock-blow gas supply opening to the reactor to peel off silicon deposited in the silicon depositing region.

6. The silicon manufacturing apparatus according to claim 5, wherein the shock-blow gas supply opening is placed below the silicon tetrachloride gas opening in the vertical direction.

7. The silicon manufacturing apparatus according to claim 5, further comprising a silicon collection vessel connected to the reactor in a lower portion thereof in the vertical direction, wherein and silicon, peeled off from the silicon depositing region, is collected in the silicon collection vessel.

8. The silicon manufacturing apparatus according to claim 7, further comprising a valve disposed between the reactor and the silicon collection vessel and operable to shut off an inside of the reactor from outside, wherein silicon, peeled off from the silicon depositing region, accumulates on the valve after which opening the valve allows silicon to be collected in the silicon collection vessel.

9. The silicon manufacturing apparatus according to claim 1, wherein the heater includes a heating section that heats the reactor in a upper region thereof from the silicon tetrachloride gas opening in the vertical direction at a temperature exceeding the silicon depositing temperature range, and a heating section that heats the reactor in a lower region thereof below the silicon tetrachloride gas opening in the vertical direction at the silicon depositing temperature range.

10. The silicon manufacturing apparatus according to claim 1, further comprising an inert gas supply pipe having an inert gas supply opening communicating with the reactor in a coaxial relationship with the silicon tetrachloride gas supply pipe to supply an inert gas from the inert gas supply opening to the reactor, wherein the inert gas supply opening is placed above the silicon tetrachloride gas supply opening in the vertical direction.

11. The silicon manufacturing apparatus according to any one of claim 1, wherein the zinc gas supply pipe is connected to the reactor through at least one of a longitudinal wall and an upper lid of the reactor.

12. The silicon manufacturing apparatus according to claim 1, wherein the reactor has a cylindrical shape and the zinc gas supply pipe communicates with the inside of the reactor through an upper lid thereof and extends in the vertical direction in a coaxial relationship with a center axis of the reactor.

13. A method of manufacturing silicon using a silicon manufacturing apparatus provided with: a reactor standing upright in a vertical direction; a silicon tetrachloride gas supply pipe connected to the reactor and having a silicon tetrachloride gas opening through which a silicon tetrachloride gas is supplied to the reactor; a zinc gas supply pipe connected to the reactor and having a zinc gas supply opening through which a zinc gas is supplied to the reactor, with the zinc gas supply opening being placed above the silicon tetrachloride gas opening in the vertical direction; and a heater that heats the reactor,
the method comprising:
setting a part of the reactor at a temperature lying in a silicon depositing temperature range;
supplying silicon tetrachloride gas from the silicon tetrachloride gas opening to the reactor;
supplying zinc gas from the zinc gas supply opening to the reactor;
reducing silicon tetrachloride with zinc in the reactor; and
forming a silicon depositing region, in which silicon is deposited on a wall portion in the reactor corresponding to a region thereof that is set to the silicon depositing temperature range.
